(19) United States
(12) Patent Application Publication
(10) Pub. No.: US 2006/0010032 A1
(43) Pub. Date: Jan. 12, 2006

(54) System, method and computer program product for evaluating an asset management business using experiential data, and applications thereof

(75) Inventors: Jill Eicher, Glencoe, IL (US); David S. Ruder II, Glenview, IL (US)

Correspondence Address: STERNE, KESSLER, GOLDSTEIN & FOX PLLC, 1100 NEW YORK AVENUE, N.W., WASHINGTON, DC, 20005, US

(73) Assignee: Blake Morrow Partners LLC, Chicago, IL (US)

(21) Appl. No.: 11/225,091

(22) Filed: Sep. 14, 2005

Related U.S. Application Data
(63) Continuation-in-part of application No. 11/005,119, filed on Dec. 6, 2004.
(60) Provisional application No. 60/527,688, filed on Dec. 5, 2003.

(51) Int. Cl. G06Q 90/00

(52) U.S. Cl. 705/10

(57) ABSTRACT

A method, system and computer program product for evaluating and quantifying the risk, performance and potential of an asset management business are disclosed. Experiential data generated by the business' processes is extracted and used as source data in evaluating the business. Experiential data includes both qualitative and quantitative information compiled from operating systems, databases, applications, workflows, interviews, paper-based files and financial records. Business processes are measured individually and then collectively to understand the business as a whole. A set of metrics and a series of algorithms are used to measure the risk, performance and potential of the business drawing from the outset on the experiential data collected and a comparison of the business process workflows to quality control checks.

### CROSS-REFERENCE TO RELATED APPLICATION

This application is a continuation-in-part of U.S. patent application Ser. No. 11/005,119, entitled “METHOD FOR EVALUATING A BUSINESS USING EXPERIENTIAL DATA,” filed on Dec. 6, 2004, which claims priority from U.S. Patent Application No. 60/527,688, entitled “METHOD FOR ASSESSING, MEASURING AND RATING OPERATIONAL PERFORMANCE OF HEDGE FUND BUSINESS,” filed on Dec. 5, 2003, all of which are herein incorporated by reference in their entireties.

### BACKGROUND

1. Field of the Invention

The present invention relates to a method of measuring enterprise risk, performance, and potential, and more particularly, measuring the enterprise risk, performance, and potential of asset management businesses.

2. Background

Businesses generally strive to improve financial performance through the traditional means of lowering costs and finding new revenue sources. Most businesses can be evaluated by examining the financial statements of the firm, and understanding basic dynamics of customers, suppliers, and competitors.

Asset management businesses, however, are different from businesses in general because their success is tied to their ability to identify, measure, and manage risk.

The asset management industry has experienced significant change in recent years due to disappointing and volatile stock market returns combined with cash and bond yields reaching historic lows. In addition, the migration of investment talent from mutual funds and traditional asset managers to alternative asset management companies (also called “hedge funds”) has prompted institutional investors to start making large allocations to alternative investment funds. The hedge fund sector has grown dramatically in recent years, as evidenced by both the number of firms and the amount of assets managed. The United States Securities and Exchange Commission estimates that the asset management will grow dramatically over the next 5 or 10 years. Others estimate the hedge fund industry will grow from a current level of $1 trillion of assets under management to more than $2 trillion by 2010.

With the growth in the asset management industry, institutional investors and government regulators have become concerned about business risk (or enterprise risk) as well as the underlying strength and stability of asset management businesses. Regulators are generally concerned with eliminating fraud and preventing systemic risk to the market. Institutional investors are concerned about meeting their fiduciary duties to their pension plans, endowments, or other asset pools. While investment performance is still important, there is increased concern and scrutiny on asset management businesses relating to risk, including investment and operational risk. There are concerns that asset management businesses may have grown too quickly to effectively manage their businesses, placing the assets under management at risk. Asset management businesses are now being evaluated across several dimensions that do not exist for most businesses in general.

While there is a desire to evaluate asset management businesses from an enterprise risk perspective and across operational performance dimensions, it has not been possible due to the shortcomings and limitations of conventional approaches to measuring and managing risk. As a result, asset management businesses have scant and fragmented information about their business risk, particularly information related to performance and potential.

To evaluate the enterprise risk and/or operational risk of an asset management business, prior art methods use loss event narrative summaries as source data, usually excerpted from loss event statistics purchased from third party sources in industries other than asset management (primarily the banking industry). This information summarizes past loss events in an effort to raise awareness and to document the type, frequency and magnitude of loss events. While instructive in understanding what happened and the resulting consequences, this approach does not lend itself to pro-active loss prevention, thus calling into question the efficacy of traditional source data and enterprise risk methods.

In the asset management industry, the data, information and systems available to manage investment portfolios and risk are highly sophisticated and comprehensive, however, there is little in the way of data, information or systems to manage investment businesses and risk. Prior art methods use portfolio performance data as the measure of how well an asset management business is performing and make no attempt to access or employ business operating data. This results in a lack of understanding about the business supporting the investment portfolio and, therefore, the risk of the asset management firm.

Lacking data, information and systems, the various constituencies of asset management businesses operate with an isolated view and do not have the means to understand the interdependencies across business lines, nor the impact of those interdependencies on the business. In addition, they do not have a quantitative framework to evaluate the business or its risk exposures as a whole. Thus, there is no enterprise, or “big picture,” view to work from either to measure business performance or to root out operational problems or inefficiencies. Further, there is no effective way to measure business risk or identify and address risk exposure issues.

To understand the ability of a asset management business to perform well in the future, prior art methods rely on past performance history despite the conventional wisdom that past performance is not indicative of future results. What's more, this data concerns only investment results and not the people, processes and technology having generated the results. Consequently, this approach does not provide a forward-looking perspective and provides little insight to understanding an asset management business.

An asset management business may use third party service providers to perform functions that may previously have been performed by the business. These activities may include fund administration, pricing of securities, a measurement of investment risk and performance. Prior art approaches do not incorporate the functions of third party service providers into the evaluation of the asset management business.

An asset management business is best analyzed by its business processes. Understanding the business processes of the individual functions and activities within an asset management business can enhance the understanding of the asset management business. This is important for individuals and organizations that select and oversee asset managers in the context of performing their fiduciary responsibilities. Prior art approaches do not operate in this manner.

Many constituencies seek data to understand the strength and risk levels of an asset management firm. These include auditors that seek data on which to base management opinions, and credit providers, that seek to understand the stability of an asset management firm and the potential risks of default on a loan, among others.

Institutional investors and their intermediaries (consultants and funds-of-funds) resort to issuing long due diligence questionnaires to potential and existing managers that they hire. These questionnaires are generally provided in typed documents, and asset managers either type responses or write in the responses in long hand. The primary limitation of due diligence questionnaires relates to the self-assessment nature of the majority of the questions. As a result, the information supplied does not lend itself well to verification. Additionally, managers respond to the questionnaires on an ad hoc basis and typically delegate their completion to non-investment personnel outside of the business areas being examined.

### SUMMARY OF THE INVENTION

The present invention provides additional methods for evaluating an asset management business, such as but not limited to an asset management business or hedge fund, by using experiential data, i.e., data produced in the course of operating the business, to measure business risk, performance, and potential (other methods are described in U.S. patent application Ser. No. 11/005,119, entitled “METHOD FOR EVALUATING AN ASSET MANAGEMENT BUSINESS USING EXPERIENTIAL DATA,” filed on Dec. 6, 2004, referenced above). The methods include (1) the identification of previously untapped data from various disparate computerized systems supporting asset management businesses and (2) automating the collection of this experiential data for the evaluation of components of an asset management business (such as a traditional asset manager, mutual fund, or hedge fund) by using the experiential data, i.e., data produced in the course of operating the business, to measure business risk, performance, and potential. The business is broken down into functions, each function being carried out through a number of activities (i.e., business processes). Each activity produces experiential data, i.e., data produced by performing the activity. Experiential data includes both qualitative and quantitative information compiled from operating systems, databases, applications, workflows, interviews, paper-based files and financial records. Activities and functions are measured individually and then collectively to understand the business as a whole. Component measures compute risk levels, confidence levels, efficiency ratings, and operational effectiveness levels.

A specific set of mathematical functions, referred to as metrics and algorithms, are applied to the collected experiential data to measure enterprise risk, performance, and potential related to component parts of the asset management business. The measures generated are expressed as values, Key Business Indicators (KBIs), Operational Performance Benchmarks (OPBs), enterprise risk, business drivers and consistency potential. These measures provide an asset management business quantitative framework for each function, activity, and the business (or enterprise) as a whole.

The inventive method measures the potential of an asset management business to perform consistently over time by assessing how effective the business processes are operating by using experiential data extracted from the full spectrum of the business' functions and activities. The extracted data is fed into a series of metrics and algorithms that measure how well an asset management business is performing from a business perspective. The information generated by the metrics is combined with a comparison of the business process workflows to applicable quality control checks, all of which is then ultimately combined, or rolled up, to assess enterprise risk, performance, and potential.

Two levels of analysis and perspective are provided, one at the functional level of the business (i.e., how well are the individual business processes performing) and the other, at the enterprise level (i.e., rolling up the business functions and activities to understand the business as a whole). In this way, the present invention provides 1) an understanding of the interdependency of the individual business functions and their impact on the business as a whole, and 2) the ability to quantify the effect and impact those interdependent relationships have on the business as a whole.

In addition, the present invention may be applied to examine specific aspects of an asset management business, and thus hone in on a particular area of concern. For example, the inventive method can be used to measure:

the level of operational risk;

the likelihood the business will perform consistently;

the effectiveness of the decision-making process;

alpha generation (growth in excess of market appreciation);

the short and long-term scalability of the business infrastructure;

the appropriateness of policies and procedures;

the adequacy of oversight and controls;

whether the business is being run responsibly; and

current practices as compared to quality control checks.

The method enables asset management businesses to utilize their own operational information to more effectively manage their businesses. Instead of having to rely on anecdotal information, they are able to manage their businesses as effectively as they manage their portfolios. The method also allows asset management businesses to provide quantitative information about their businesses to the financial institutions employing them as a supplement to traditional investment results and qualitative survey information.

In further detail, the method comprises the steps of gathering data across the activities of the business and applying a set of metrics to the data to produce measures to determine how well the business processes are performing as expressed in values and other measures such as key business indicators; comparing the business processes (activities) workflows to best practices (i.e., applicable quality control checks) to identify risk exposures; rolling up the activity measures for each function to understand how well the functions are performing as expressed in values and other measures such as key business indicators; combining all of the data generated to compute operational performance measures as expressed in terms of the business drivers (productivity, profitability, scalability, alpha generation and risk); combining all of the data generated to calculate enterprise risk and potential as expressed as a value.

In embodiments of the invention, the functions described herein are performed automatically using one or more computers. In other embodiments, some manual intervention is involved in some of the functions described herein. Implementation of these embodiments via software and hardware will be apparent to persons skilled in the art based on the teachings contained herein.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the broad steps of the method in accordance with an embodiment of the present invention.

FIG. 2 illustrates an exemplary set of metrics, KBIs and their corresponding Business Drivers for the trade capture activity (process) in accordance with the method of the present invention.

FIG. 3 is a flow chart illustrating the steps of the method in accordance with an embodiment of the present invention.

FIG. 4 is an exemplary set of experiential data for a trade capture activity in accordance with an embodiment of the present invention.

FIG. 5 is a mapped workflow of the trade capture process according to an embodiment of the present invention.

FIG. 6 is a comparison of the mapped workflow from FIG. 5 with applicable quality control checks (also called industry best practices) according to an embodiment of the present invention.

FIGS. 7A-7G are data flow diagrams illustrating the operation of an embodiment of the invention.

FIG. 8 illustrates the configuration of measures according to an embodiment of the invention.

FIG. 9 illustrates the configuration of activity KBIs according to an embodiment of the invention.

FIG. 10 is a data flow diagram illustrating the Operation Function and its associated activities according to an embodiment of the invention.

FIG. 11 illustrates an example method for the analysis of the trade processing activity of the Operation Function of an asset management firm.

FIG. 12 illustrates an example method for the analysis of the corporate action processing activity of the Operation Function of an asset management firm.

FIG. 13 illustrates an example method for the analysis of the pricing of the Treasury Function of an asset management firm.

FIG. 14 illustrates an example method for the analysis of the data management activity of the Information Technology Function of an asset management firm.

FIG. 15 is an example computer system used to implement embodiments of the present invention.

FIG. 16 is an asset management evaluation system according to an embodiment of the invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION

1. Operational Description: Overview

The present invention provides a method whereby the experiential data of an asset management business is used to measure enterprise risk, performance, and the potential of the business to perform consistently over time. To do so, the method uses the experiential data of the business to fuel specific, predetermined mathematical functions, or metrics and algorithms, to measure the business in terms of the specific drivers of an asset management business: productivity, scalability, profitability, alpha generation and enterprise risk.

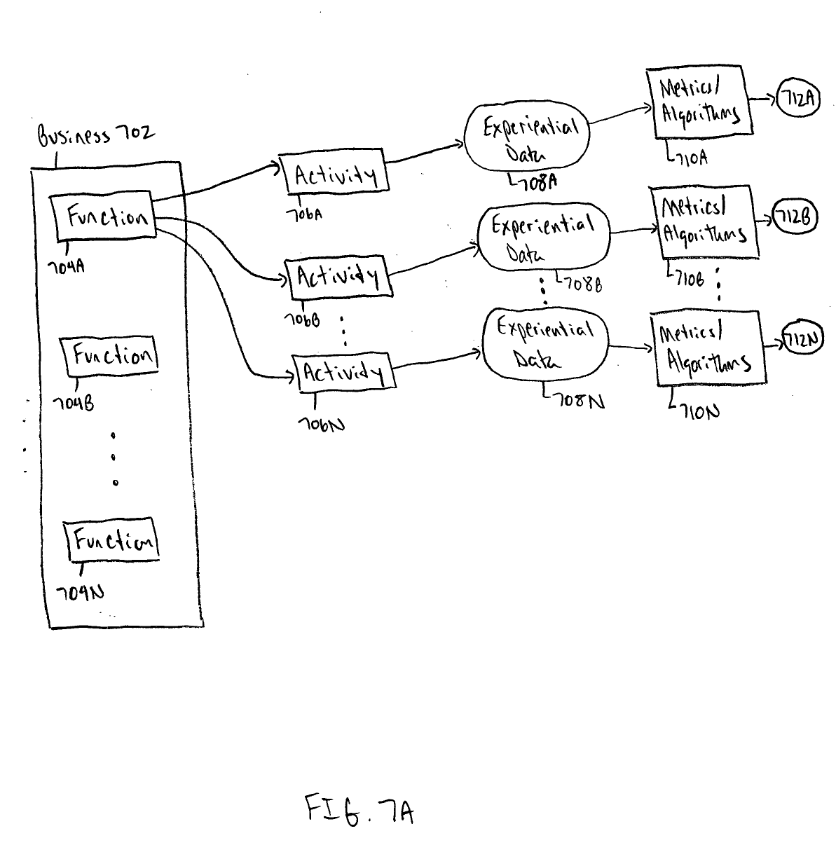

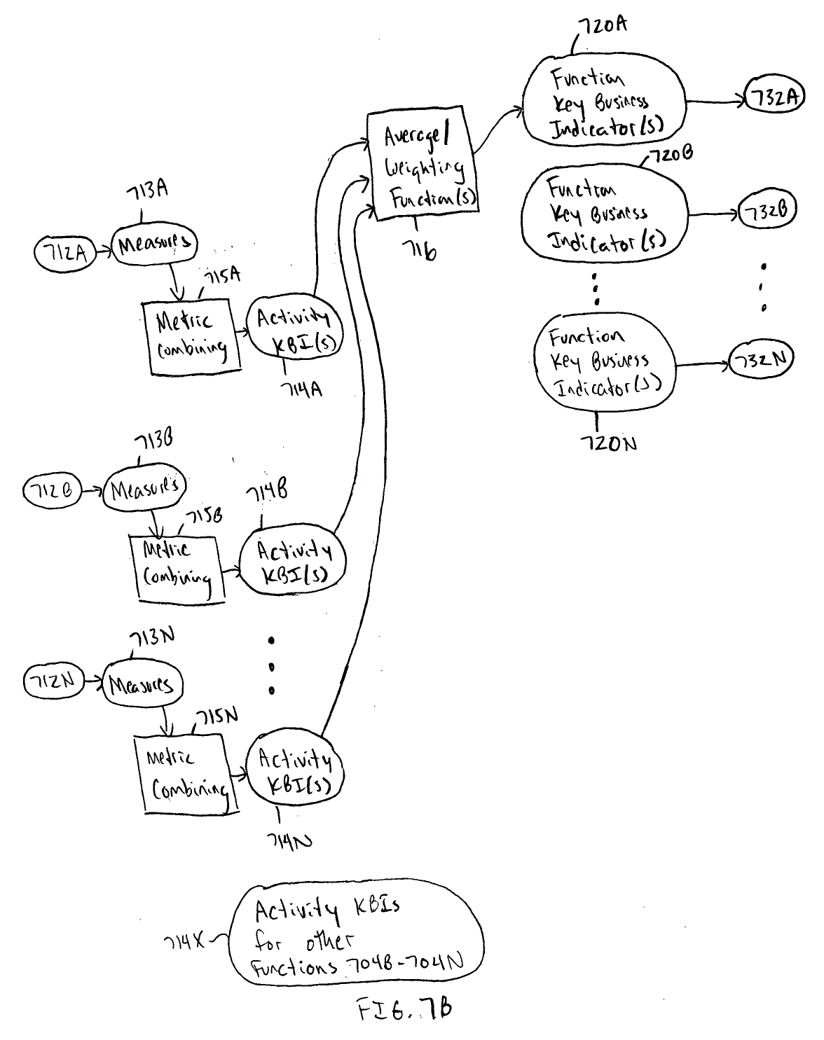

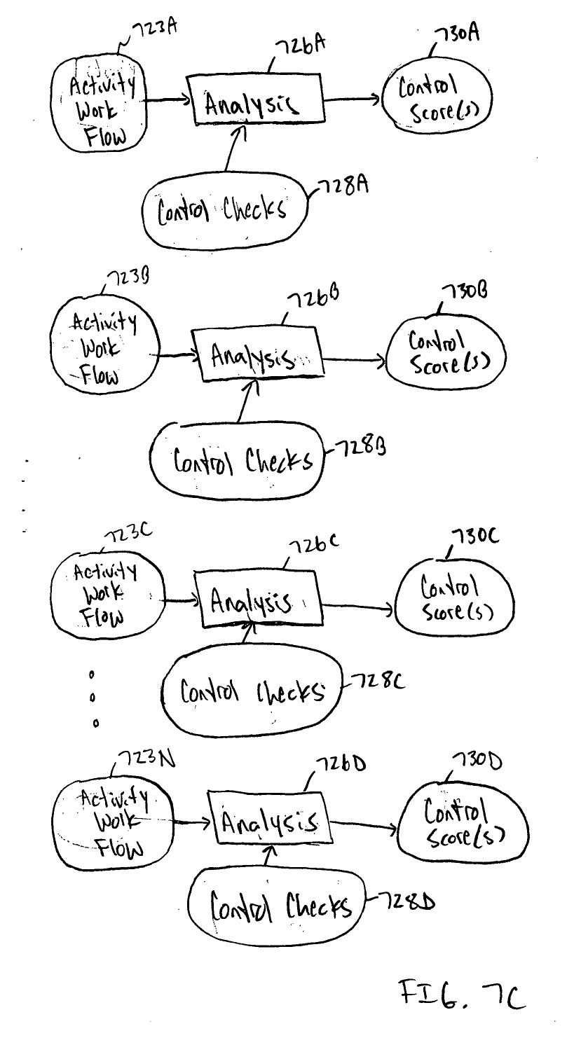

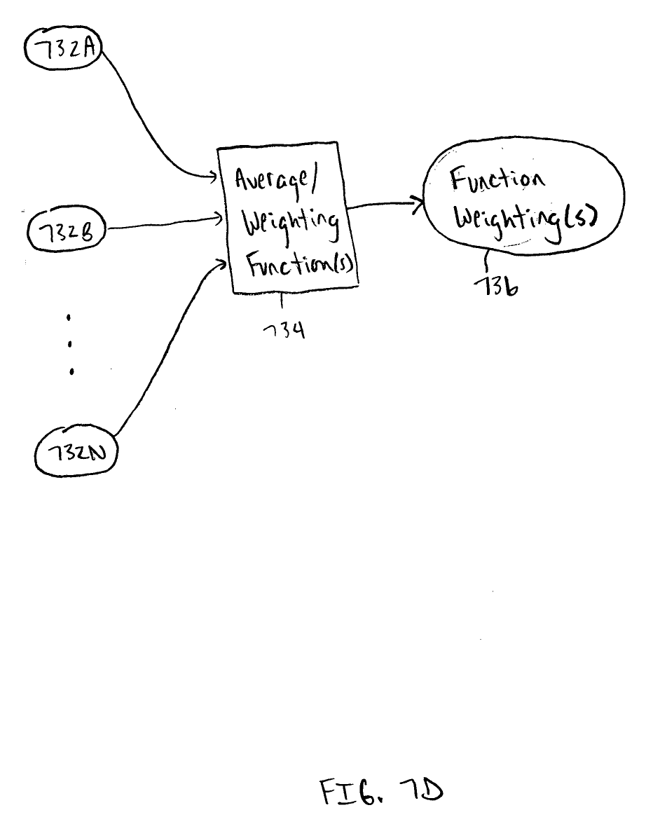

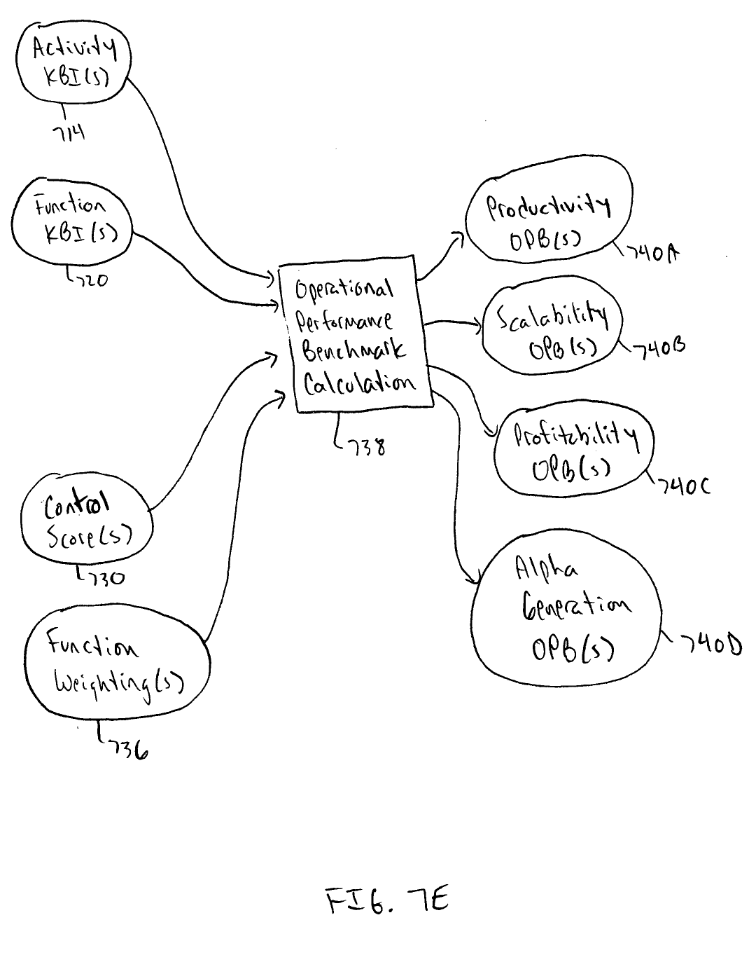

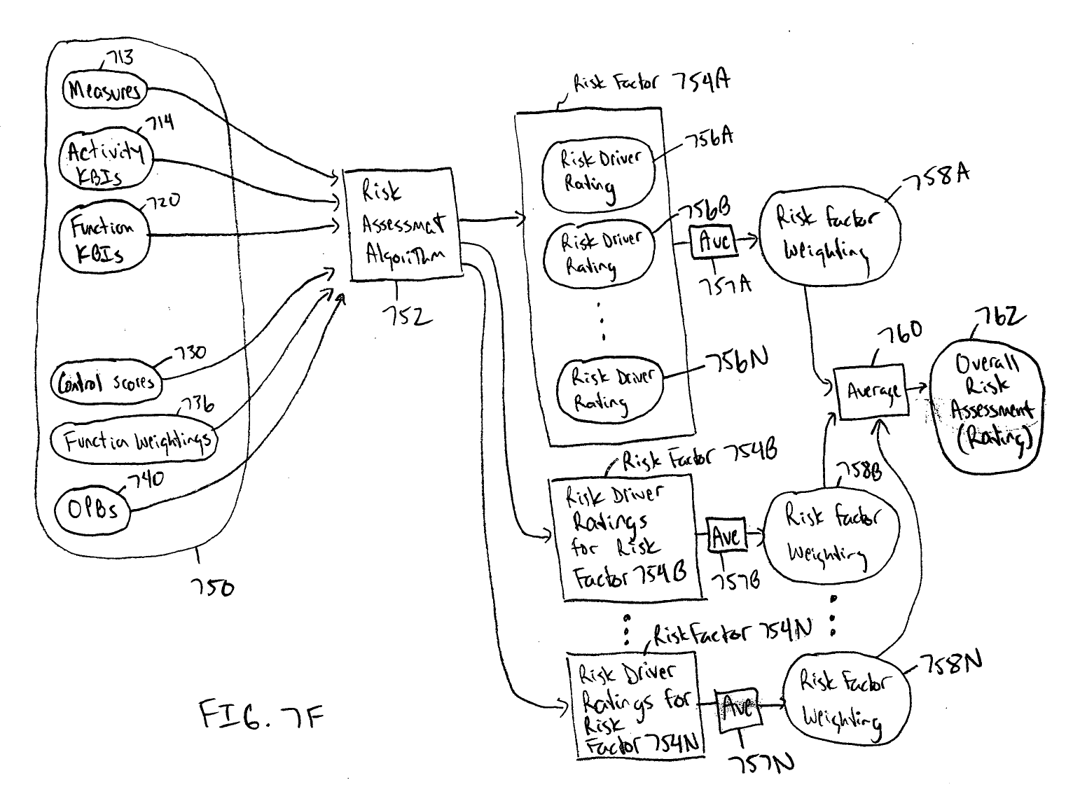

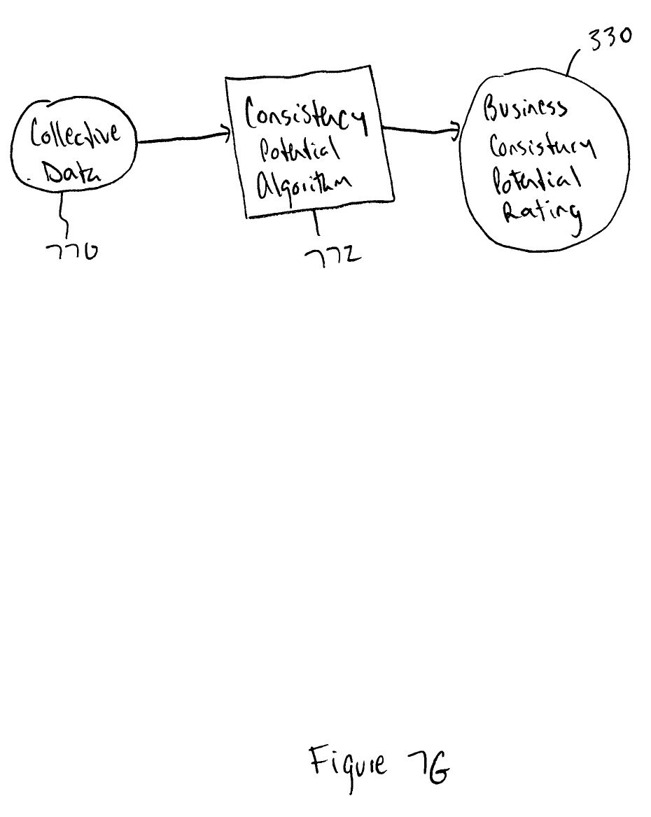

The first step is gathering data. The data is compiled from the business processes supporting the functions and activities of the business being evaluated. Businesses are often thought of in terms of departments, however, the inventive method organizes an asset management business by function and activity for greater specificity. Within each function is a sub-set of activities that make up the function. This is illustrated in the example data flow diagram of FIGS. 7A-7G. In particular, FIG. 7A illustrates an example business 702. The business 702 is organized according to the functions that it performs. These functions are illustrated as functions 704 (specified, for example, in Table 1). Each function 704 includes a number of activities 706. For ease of illustration, only the activities 706A-706N for function 704A are shown in FIG. 7A. An exemplary set of functions and their associated activities are listed in Table 1.

TABLE 1
Business Organization by Function and Activity.

| Function | Activities |
|---|---|
| (such as functions | (such as activities |
| 704 in FIG. 7A) | 706 in FIG. 7A) |
| Research | Idea generation |
| | Implementation strategy |
| Portfolio Management | Investment due diligence |
| | Strategy & execution |
| | Investment risk management |
| Sales | Market research |
| | New business |
| | Prospective development |
| Client Service | Communication |
| | Retention |
| Management/General | Alpha generation |
| Partners | Business strategy & execution |
| | Compensation |
| | Governance/ownership |
| Treasury | Cash management |
| | Human resources |
| | Margin/financing |
| | Securities lending |
| Compliance | Business risk management |
| | External compliance |
| | Internal oversight |
| Controller | Audit/tax |
| | Corporate finance |
| | Portfolio (Partnership) accounting & |
| | reconciliation |
| | Pricing |
| Operations | Corporate actions |
| | Portfolio recordkeeping |
| | Proxy voting |
| | Trade capture |
| | Trade error resolution |
| | Trade settlement |
| Information Technology | Business continuity |
| | Data management |
| | Security |
| | System administration |
| | System development |
| | Web presence |

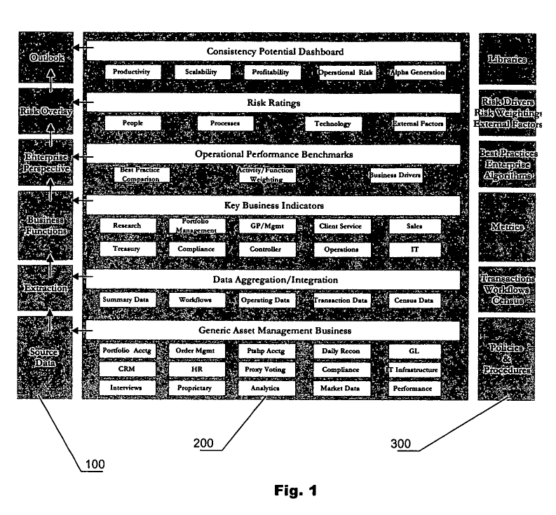

FIG. 1 illustrates the major, broad steps and information involved with an embodiment of the inventive method, working from the bottom of the diagram to the top. The left column 100 represents a broad description of the general steps for the present invention. The middle column 200 represents the data associated with each step at its respective horizontal position. For example, the Extraction step (in the left column 100) is on the same line as “Summary Data,” “Workflows,” “Operating Data,” and Transaction Data.” The step of Extraction produces the data groups listed next to it. The column 300 on the right is a list of the libraries, or databases in which information is organized and maintained. The operation depicted in FIG. 1 shall be described with reference to the example data flow diagram of FIGS. 7A-7G.

As previously mentioned, the first step is to collect source (or experiential) data (as noted at the bottom of the left column 100). The systems and areas of an asset management business generating the source data are listed next to “Source Data”. Above “Source Data” is “Extraction” with the extraction results listed next to it. Referring to the example of FIG. 7A, source data (or experiential data 708), is generated when activities 706 corresponding to the functions 704 of the business 702 are performed. Such experiential data 708 is collected in this first step.

In the next (“Business Functions”) step, metrics are applied to source data 200 to measure the performance of the functions and activities supporting the business. These measures, or criteria, may be expressed as values or as key business indicators (KBIs).

For example, the Research Function of FIG. 1 includes two activities, Idea Generation and Implementation Strategy (as detailed in Table 1). In other words, the Research function generates ideas and formulates strategies for implementing those ideas. The Research function's business processes are scrutinized and subjected to specific statistical and mathematical analysis represented by a set of metrics designed to evaluate the specific activities of the Research function.

Assume a set of metrics for the Research function measures the productivity of the activities. For example, to measure the productivity of “Idea Generation,” the frequency with which new ideas are generated, the quality of the ideas, and whether they are generated on a timely basis, would all be considered. Each of these criteria can be measured by metrics. Metrics may also be a certain statistical analysis, for example, the percentage of ideas generated that increase investment results. The metrics for “Implementation Strategy” might then include the frequency with which strategies are formulated, the quality of the strategy, and whether they are implemented on a timely basis.

These metrics establish a baseline of current operational performance that comprises the foundation to understanding how well the business is performing. In this example, the metrics are designed to gauge how well the people, processes and technology involved in the activities within the Research function are performing. By using the experiential data of the business activities to establish a baseline of performance, the business owner can evaluate the effectiveness of the activities over time as well as measure the impact of business dynamics on the activities.

In the example of FIG. 7A, such metrics and algorithms 710 are applied to the experiential data 708 to generate measures 713 (see FIG. 7B).

Next in the Business Functions step, Key Business Indicators (KBIs) are calculated for each activity to measure how well the specific activity is performing. For example, a KBI for Idea Generation might be “the number of new ideas generated in the period that were presented to the investment committee and given a green light for further analysis.” A KBI for the Implementation Strategy might be “the number of new ideas approved for implementation into the portfolio”. A KBI is a definitive, quantitative measure of each activity's performance. In the example of FIG. 7B, such KBIs are shown as activity KBIs 714. They are called “activity” KBIs 714 because each corresponds to an activity 706, and each represents a key business indicator for that corresponding activity 706. In FIG. 7B, the activity KBIs 714 are shown as being generated by selective combination 715 of the measures 713.

In the next step, to quantify and determine the performance of the Research function as a whole, the activities within the function are weighted by their importance to the function. That is to say, the Research function KBI score is calculated by averaging the weighted KBIs of Idea Generation and Implementation Strategy, the two activities that comprise the Research function. Referring to FIGS. 7A and 7B, for example, note that the activity KBIs 714A-714N all correspond to function 704A. More particularly, the activity KBIs 714A-714N shown in FIG. 7B all correspond to activities 706A-706N that are part of function 704A. In this step, the activity KBIs 714A-714N for function 704A are averaged and weighted 716 to produce function key business indicator(s) 720A for function 704A. In a similar manner, function KBIs 720B-720N for the other functions 704B-704N of the business 702 are generated. The KBIs 720 generated in this step are called “function” KBIs 720 because each corresponds to a function 704, and each represents a key business indicator for that corresponding function 704.

The analysis continues by shifting focus from the functional level of the business to the enterprise level. From the point of view of FIGS. 7A and 7B, the analysis up to this point has focused on evaluating each function (such as function 704A) independently of other functions 704 (such as functions 704B-704N). The analysis now turns to evaluating the business 702 as a whole, which will involve (but not limited to) analysis of the functions 704 in combination. As part of the steps described above, the activity KBIs 714 for all the functions 704 are calculated in the same way as the example set out above for the Research Function. In the example of FIG. 7B, the activity KBIs for functions 704B-704N are collectively represented by activity KBIs 714X.

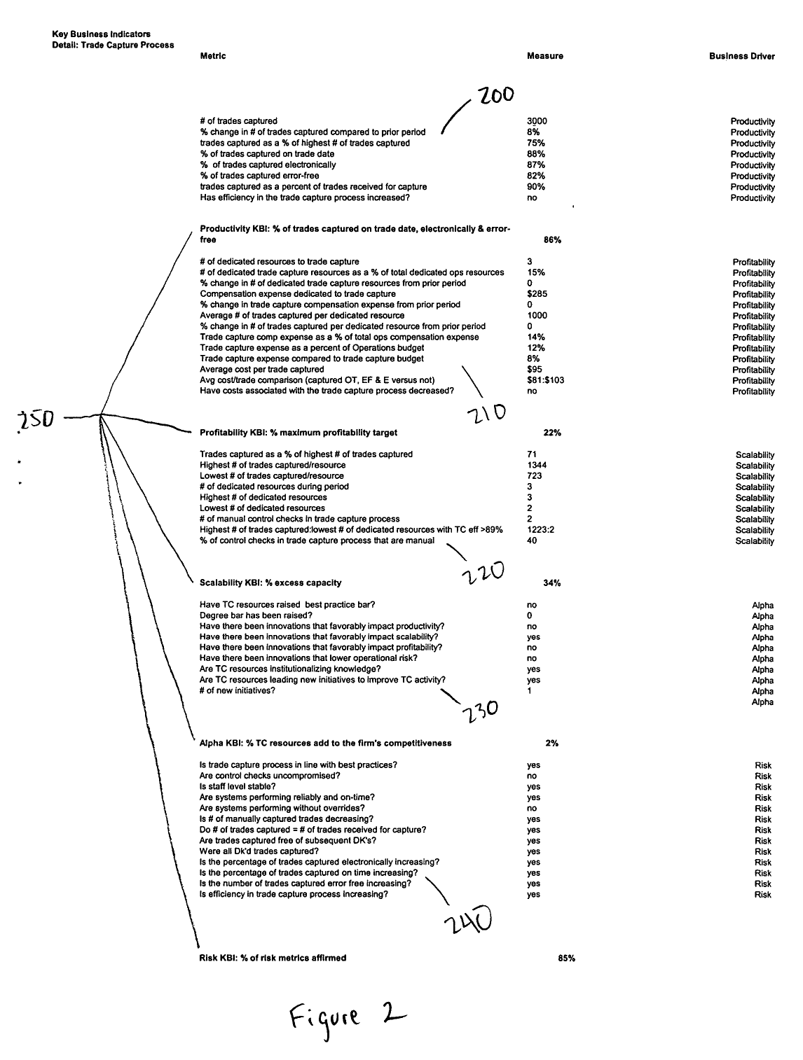

The shift to the enterprise level begins by first noting that the metrics and KBIs are associated with business drivers. As discussed previously, and shown in FIG. 2, each metric and KBI is linked at the outset to one of five business drivers: productivity, scalability, profitability, risk or alpha generation. An example of a productivity metric has already been used in the discussion of Research activities and functions (“the number of new ideas generated in the period that were presented to the investment committee and were approved by the committee for further analysis.”). Additionally, FIG. 2 provides more examples of activities metrics and their corresponding business drivers as will be discussed below.

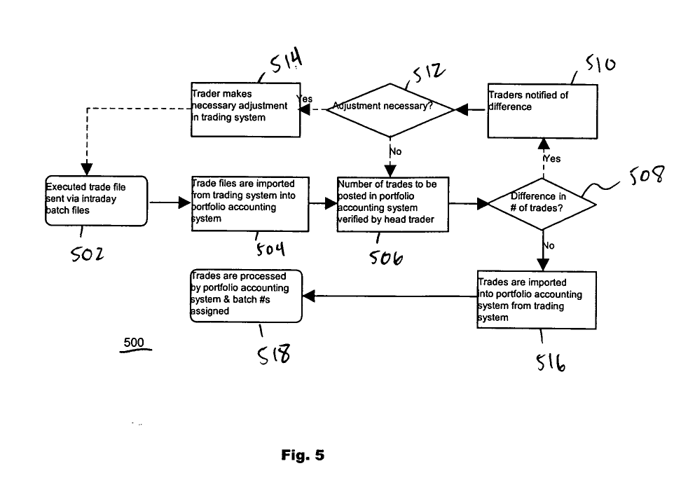

In the next step, business process workflows of the activities 706 are analyzed to determine if they include applicable control checks. This is represented in the example of FIG. 7C by analysis modules 726 receiving as input activity work flows 723 and control checks 728. The analysis modules 726 determine whether the activity work flows 723 include the control checks 728. Prior to performance of this step, the business process workflows associated with the activities 706 are determined. Such workflows are part of the experiential data 708. For example, FIG. 5 illustrates an example workflow 500 for the trade capture activity, and includes the steps that are taken in capturing a trade in the business 702 being evaluated. Workflow 500 operates as follows. In steps 502 and 504, the trades executed during the day are imported from the trading system into the portfolio accounting system. In step 506, the head trader confirms the number of trades posted in the portfolio accounting system. For example, if 10 trades were executed by the trading system, then 10 trades should have been imported into the portfolio accounting system in step 504. If there is a difference (step 508), then adjustments are made (steps 510, 512, and 514).

Activity work flows 723 typically include a number of control checks 728. A control check is a point in the work flow 723 where the accuracy of the performance of the work flow 723 is determined. In the example of FIG. 5, step 506 constitutes a control check 728. There is a set of control checks 728 associated with each activity 706. The control checks 728 for a given activity 706 depend on the nature of such activity 706, and are thus implementation dependent.

Difference businesses may have different workflows 723 for a given activity 706. Different workflows 723 for a given activity 706 may have different sets of control checks 728. Omission of a control check 728, however, represents a potential risk with the particular work flow 723. Accordingly, in this step, the activity workflows 723 are analyzed 726 to determine if they have the applicable control checks 728. The result of this analysis 726 are represented by control scores 730 (described in more detail below).

Example control checks 728 for the Idea Generation activity include: 1) documenting the inspiration source for the new idea; 2) documenting the source data used in formulating the new idea; and 3) dating, documenting and signing all the steps in the formulating of the new idea. Enhancements to, or deviations from, these control checks are scored. In this way, the inventive method provides a quantitative framework to easily identify and quantify performance contributors or detractors.

In the next step, the functions 704 are weighted by their importance to the business. These weightings are determined by a proprietary series of algorithms designed to account for the interdependence of the functions 704. In the example embodiment of FIGS. 7B and 7D, this step is achieved by averaging/weighting 734 the previously determined function KBIs 720 to generate function weighting(s) 736.

In the next step, the collective information generated in the prior steps—metrics (represented by measures 713 in FIG. 7B), KBIs (activity KBIs 714 and function KBIs 720), control check scores 730 and function weightings 736—is then used to calculate the productivity, scalability, profitability and alpha generation levels of the business 702. These measures are intermediate calculations and referred to as the Operational Performance Benchmarks (OPBs) for the purposes of this explanation as they do not yet include an operational risk perspective. The OPBs provide an understanding of the interdependence of the business activities and functions and their relation to the business as a whole. This step is depicted in the example of FIG. 7E, where productivity OPBs 740A, scalability OPBs 740B, profitability OPBs 740C, and alpha generation OPBs 740D are generated 738 from activity KBIs 714, function KBIs 720, control check scores 730 and/or function weightings 736.

After the Operational Performance Benchmarks 740 have been computed, a risk assessment is performed. The risk assessment is based on a number of factors, typically those that create a risk. For example, people, processes, technology and external factors. These risk factors are detailed in Table 2.

TABLE 2
Risk Factors.

| Risk Factors | Drivers |
|---|---|
| People | Appropriateness of skills & experience |
| | Adequacy of resources |
| | Stability of staff |
| | Commitment to ethics |
| | Level of oversight |
| Processes | Effectiveness of control checks |
| | Prevalence of manual processes |
| | Awareness of risk exposures |
| | Accuracy & timeliness of data access, handling, |
| | processing & delivery |
| | Separation of responsibilities, control checks & |
| | oversight |
| | Clarity of policies and procedures |
| Technology | Reliability |
| | Redundancy |
| | Security |
| | Contingency |
| External Factors | Awareness of external factors (physical |
| | environment, counterparty, regulatory) |
| | Preparedness to respond to external factors |

Risk assessment is accomplished by applying a risk assessment algorithm to the collective data to measure the operational risk of the activities, functions and the business as a whole. The KBIs and OPBs are then adjusted and weighted for operational risk resulting in final measures of productivity, scalability, profitability, alpha generation and operational risk for the business, or enterprise, as a whole. FIG. 7F illustrates an example data flow diagram of the risk assessment function. FIG. 7F is described in detail below.

The method culminates in computing a measure of the consistency potential of the business by factoring the pre-selected business drivers together, the process of which is described below. Staying with our previous example for consistency, there are five business drivers: productivity, profitability, scalability, alpha generation and enterprise risk. FIG. 7G illustrates an example data flow diagram illustrating how the consistency potential of the business is measured. FIG. 7G is described in detail below.

2. Operational Description: Detailed Description

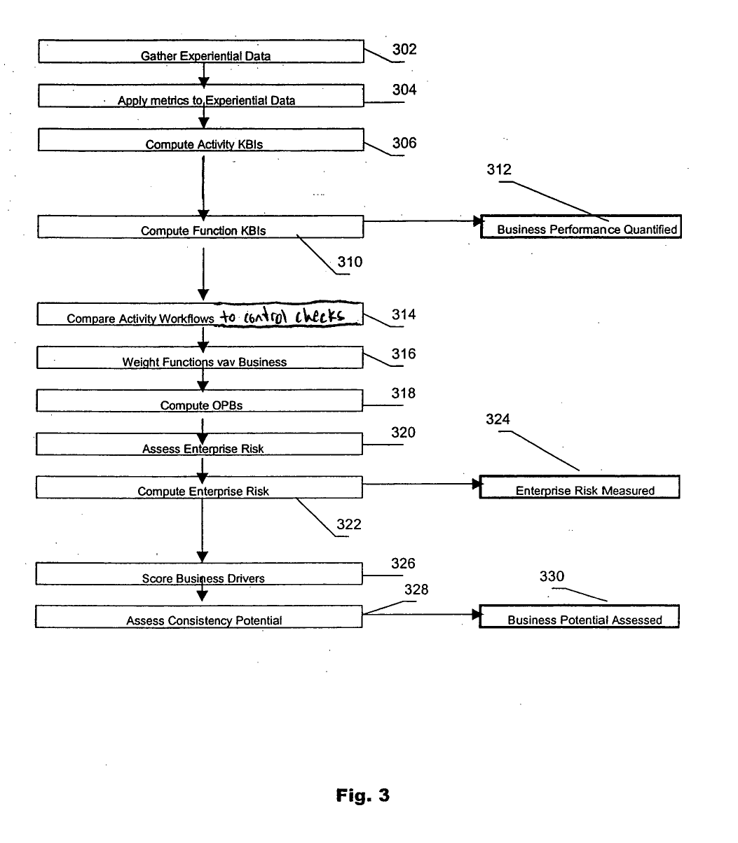

Operation of embodiments of the invention shall now be described in greater detail with reference to FIG. 3, which is a flowchart illustrating the method according to a preferred embodiment of the present invention. The operation depicted in the embodiment of FIG. 3 shall be described with reference to the example data flow diagram of FIGS. 7A-7G. For further illustration, the inventive method is applied to the Trade Capture activity of the Operations function to provide a detailed example.

The first step is to collect relevant data (step 302). For this example, since the Trade Capture Activity is being evaluated, the relevant data includes the experiential data (data from experience) produced by the trade capture activity. This data may be obtained from interviews, operating systems, applications, workflows, databases, paper-based files and financial records.

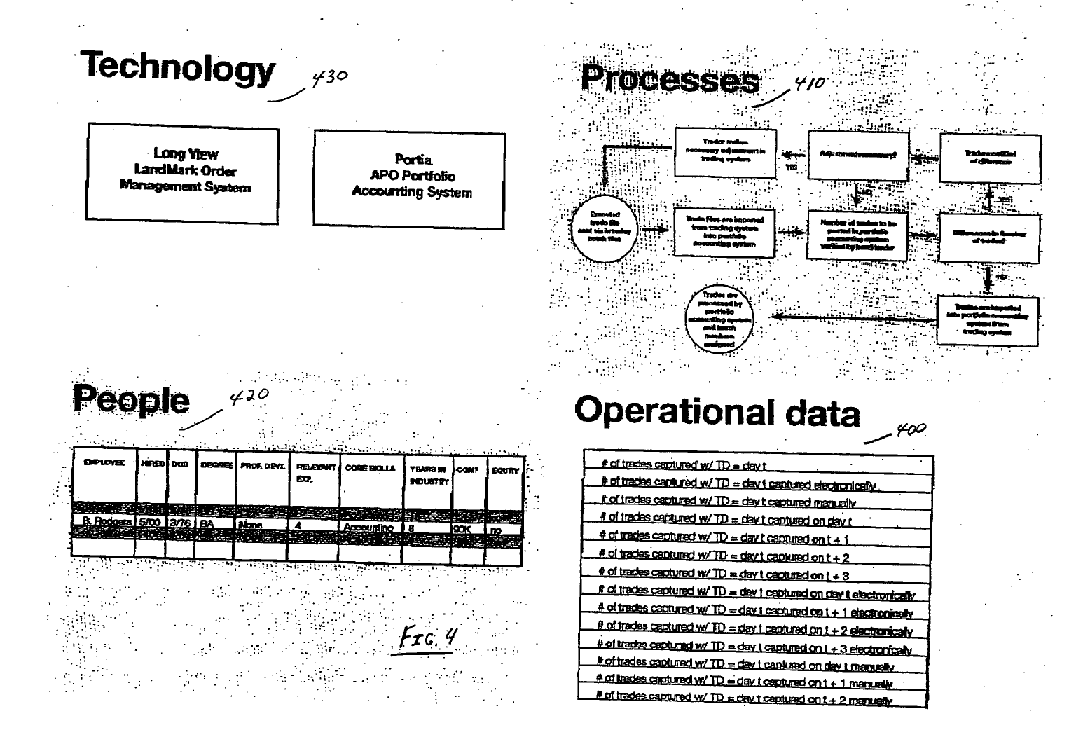

An exemplary set of relevant experiential data is listed in FIG. 4. In this example, the experiential data includes operational data 400, processes (mapped workflows) 410, people (census information) 420 and technology systems 430.

Referring to the example of FIG. 7A, source data, or experiential data 708, is generated when activities 706 corresponding to the functions 704 of the business 702 are performed. Such experiential data 708 is collected in step 302.

Referring back to FIG. 3, once the relevant data is collected (step 302), a specific set of metrics is applied to the collected operating data (step 304). These metrics translate the raw operating data into measures that correspond to a specific driver. For this example, there are five business drivers: productivity, scalability, profitability, alpha generation and risk. The first three are familiar in the business world and self-explanatory. The fourth, Alpha Generation, is the contribution by the people of the asset management business in excess of industry standards. For example, the alpha generated by the portfolio managers of the asset management business could be defined as their contribution to financial growth or profit realized, in excess of market appreciation. So, if the relevant market grew by 10% and the asset management business realized a profit of 15%, its' alpha contribution was 5%, i.e., the excess realized profit over market appreciation.

In this example, the inventive method uses five business drivers as the criteria by which the method measures a asset management organization. They are: productivity, scalability, profitability, alpha generation and enterprise risk. All metrics are linked to one of the business drivers.

For each activity, there is a specific, corresponding set of metrics to be applied to the activity's relevant experiential data. The number of metrics and the ones used will depend on the activity being evaluated. Each activity is measured by a set of metrics linked to an asset management business driver: productivity, scalability, profitability, alpha generation and enterprise risk.

In this example using trade capture productivity metrics for productivity, the metrics are applied to the relevant experiential data and scored using simple math as shown in Table 3. The calculation results of Table 3 are only examples and the values have been arbitrarily chosen.

TABLE 3
Trade Capture Metrics for Productivity

Percent of trades captured on trade date = (trades captured on trade
date/total number of trades = 88%)
Percent of trades captured electronically = (trades captured electronically/
total number of trades captured = 87%)
Percent of trades captured error-free = (trades captured error-free/total
number of trades captured = 82%)

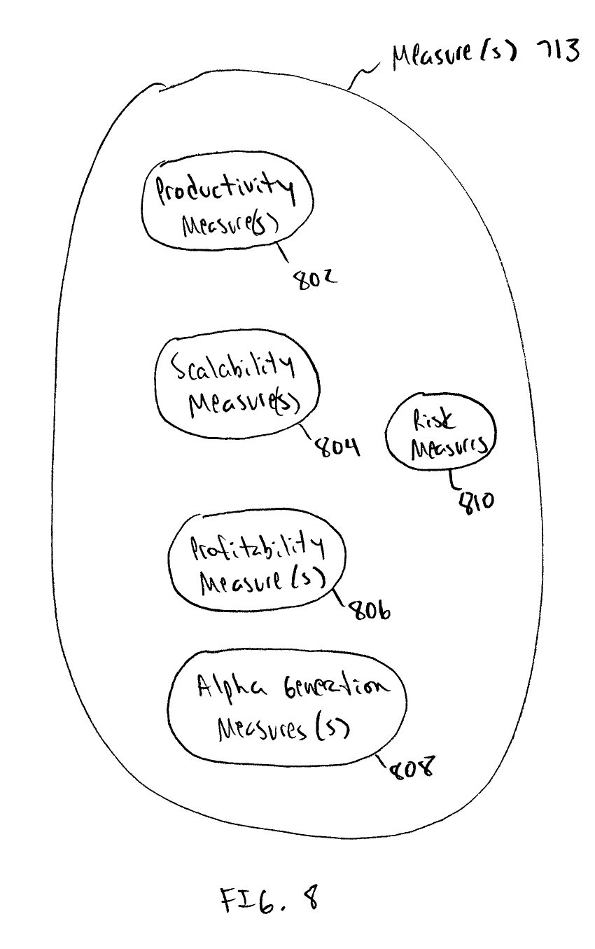

Step 304, as just described, is represented in the example of FIG. 7A by metrics and algorithms 710 being applied to the experiential data 708 to generate measures 713 (see FIG. 7B). As shown in FIG. 8, each measure 713 may include measures corresponding to the business drivers (see FIG. 2). Thus, any given measure 713 may include productivity measure(s) 802, scalability measure(s) 804, profitability measure(s) 806, alpha generation measure(s) 808 and/or risk measures 810. For example, measures 713A may include productivity measure(s) 802, scalability measure(s) 804, profitability measure(s) 806, alpha generation measure(s) 808 and/or risk measures 810, all of which are generated by metrics/algorithms 710A from experiential data 708A.

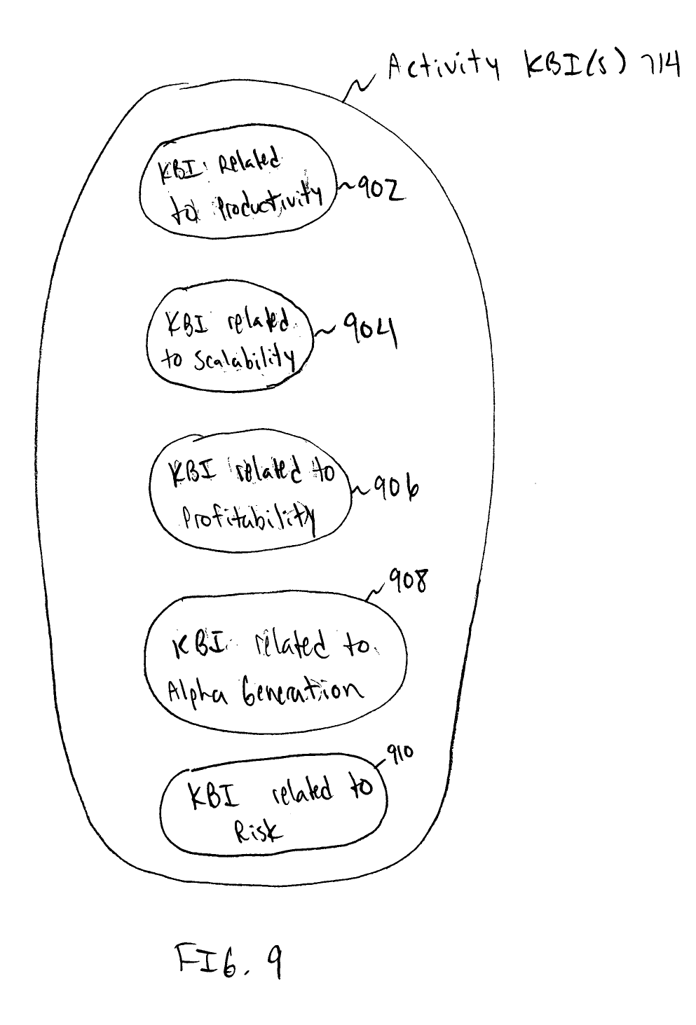

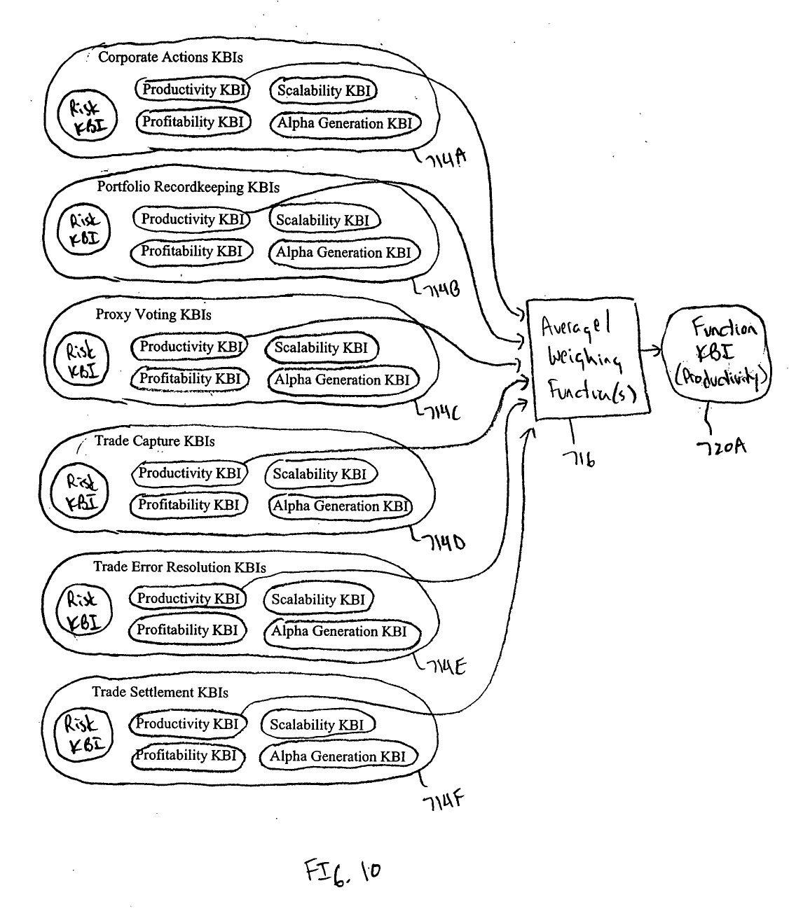

After the metrics are scored, an activity KBI 714 measuring trade capture productivity is calculated using, for example, simple math, such as a simple or weighted average (step 306). The activity KBI 714 is a predetermined measure of how well the particular activity 706 is being performed. The activity KBI 714, like the set of metrics 710, is different for every activity 706 and for each business driver. Thus, there are five different activity KBIs 714 for the Trade Capture 706 activity, one relating to each business driver. This is generally shown in FIG. 9. An exemplary set of KBIs for the Trade Capture Activity is listed in Table 4.

TABLE 4
Trade Capture Activity KBIs.

| | Activity KBI |
|---|---|
| Business Driver | (such as activity KBIs 714 in FIG. 7B) |
| Productivity | Percent of trades captured on trade date, electronically |
| | and error-free. |
| Profitability | Percent of maximum profitability target. |
| Scalability | Excess capacity. |
| Alpha | Percent of trade capture resources that add to the |
| | firm's competitiveness. |

In this example, the Trade Capture Activity as it affects the driver Productivity, or, more simply put, trade capture productivity, is being evaluated. So the activity KBI corresponding to trade capture productivity is selected and applied to the metrics in Table 3 (step 306). In this example, for the Trade Capture Activity, the percentage of trades that are captured on trade date, electronically, and error free is the strongest indicator of operational performance of the Trade Capture Activity with respect to Productivity.

Step 306 shall now be further described. Values 713 obtained by the metrics 710 can be combined to generate new information 714. The combination can be via a simple average or a weighted average, for example. Weights are implementation dependent and can be set, for example, based on the relative impact of the factors on the business, functions and/or activities (this is generally the case for all weights described herein). In the present example, looking at the values obtained by the metrics, the percentage of trades captured on the trade date, 88%, the trades captured electronically, 87%, and trades captured error-free, 82%, are extracted and their average obtained. In this case, the average of the three metrics is 85.6% or 86%. So, 86% (out of a possible 100%) of the trades captured are done so electronically, on the trade date and error-free. This value serves as the indicator of productivity for the Trade Capture Activity.

As indicated above, step 306 operates to calculate, for the Trade Capture activity, activity KBIs 714 for the three other business drivers as well, following the same steps as described above for the trade capture productivity KBI (see again FIG. 9). FIG. 2 lists the Productivity Metrics 200, the Profitability Metrics 210, the Scalability Metrics 220, the Alpha Generation Metrics 230, and the Risk Metrics 240 along with their respective KBIs 250. Averages (simple or weighted) and percentages are obtained in the ordinary manner as is commonly known and practiced in the field of mathematics.

Step 306 is represented in the example of FIG. 7B by measures 713 being combined 715 to generate activity KBIs 714. Step 306 could alternatively be viewed as combinations of metrics 710 being selected and applied to experiential data 708 to generate activity KBIs 714, without the intermediate step of generating measures 713.

Steps 302, 304 and 306 operate to generate measures 713 (in the form shown in FIG. 8) for all the activities 706 of all the functions 704, in the manner described above. Also, steps 302, 304 and 306 operate to generate activity KBIs 714 (in the form shown in FIG. 9) for all the activities 706 of all the functions 704, in the manner described above. Reference number 714X represents activity KBIs for the other functions 704B-704N.

In step 310, function KBIs 720 are calculated for each function 704, by taking a simple or weighted average of the activity KBIs 714 associated with that function 704. For example, the Trade Capture activity KBI, along with the five other activity KBIs 714 within the Operations Function listed in Table 1, are averaged by their productivity activity KBIs 902, which is selected as the Primary Business Driver of the Operations Function to provide a quantified analysis of the Operations Function, also called the function KBI 720 or Performance Rating 312.

An exemplary set of Primary Business Drivers for each function 704 of an asset management business 702 is detailed in Table 5. The Primary Business Driver for each Function 704 is the Driver that is most effected by the Function 704. So, for example, Sales affects Profitability more than the other Drivers.

TABLE 5
Primary Business Drivers.

| Function 704 | Primary Business Driver |
|---|---|
| Research | Alpha Generation |
| Portfolio Management | Alpha Generation |
| GP/Management | Alpha Generation |
| Client Service | Profitability |
| Sales | Profitability |
| Treasury | Profitability |
| Compliance | Operational Risk |
| Controller | Operational Risk |
| Operations | Productivity |
| IT | Scalability |

Operation of step 310 is represented in the example of FIG. 7B by the generation of function KBIs 720. Function KBIs 720 are generated for each function 704. For example, in this step 310, the activity KBIs 714A-714N for function 704A are averaged and weighted 716 to produce function key business indicator(s) 720A for function 704A. In a similar manner, function KBIs 720B-720N for the other functions 704B-704N of the business 702 are generated using their respective activity KBIs 714X.

To summarize so far, the measures 713, activity KBIs 714 and function KBIs 720 represent quantitative measures of how well the activities 706 and functions 704 of the business 702 are performing.

According to embodiments of the invention, the focus shifts to overall business, or enterprise, performance. The inventive method begins this next phase by utilizing the activity workflows 723 gathered as experiential data (410 of FIG. 4). The trade capture activity workflow 500 is illustrated in the example of trade capture in FIG. 5, generally indicated by reference numeral 500. The mapped workflow 500 is a flowchart for the steps that are taken in capturing a trade in the business being evaluated. The mapped workflow identifies the steps in the trade capture process. The workflow includes internal control checks (see Table 6, for example), which the invention in step 314 (below) compares to control checks 728 applicable to each activity 706.

The mapped workflow 723 of each activity 706 is compared to the applicable set of control checks 728 (step 314). Table 6 lists example control checks 728 for the trade capture activity.

TABLE 6
Industry Best Practices (Quality Control Checks) for Trade Capture.

Verification of number of trades (inbound)
Verification of number of trades (outbound)
Holdings check before trade capture
Authorization check before trade capture
Use of standard trade format
Time stamp (inbound)
Time stamp (outbound)
Assigned batch numbers to processed trades

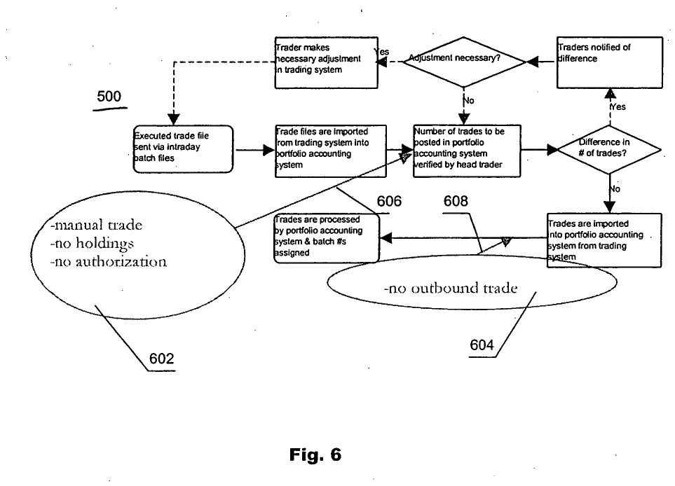

A comparison between the mapped workflow 500 and the control checks 728 is made. The comparison between the Trade Capture Activity workflow and the control checks 728 is shown graphically in FIG. 6.

In the comparison process, enhancements to and deviations from the control checks 728 are generated by automated workflow comparison software technology. In the example of FIG. 6, the deviations from the control checks 728 include (1) executing trades manually, (2) not holding checks before a trade capture, and (3) not authorizing a check before trade capture 602. A link 606 shows where in the evaluated process 500 the deviation occurs. Another deviation occurs when the number of outbound trades is not verified 604. A corresponding link 608 indicates where, in the process, the number of outbound trades should be verified.

The impact of each enhancement and/or deviation is linked to one of the five business drivers: productivity, scalability, profitability, alpha generation or enterprise risk. For example, variances between the Trade Capture Activity workflow and applicable control checks 728 are shown in Table 7. An “X” indicates that the variance has an impact on the particular driver.

TABLE 7
Variances From Industry Best Practices (Quality Control Checks)

| | Productivity | Scalability | Profitability | Alpha | Risk |
|---|---|---|---|---|---|
| Variance | Impact | Impact | Impact | Impact | Impact |
| Manual trade | X | X | X | | X |
| verification | | | | | |
| No holdings | | | | | X |
| check before | | | | | |
| trade capture | | | | | |
| No | | | | | X |
| authorization | | | | | |
| check before | | | | | |
| trade capture | | | | | |
| No outbound | | | | | X |
| trade | | | | | |
| verification | | | | | |

The variances (602 and 604 in FIG. 6) found in the comparison of the mapped workflow activity to control checks 728 are then scored beginning with an impressed base score of 50.

Each variance has a pre-determined weight depending on the business driver impacted by the variance. The pre-determined weights are configured prior to the analysis either by (1) accepting default settings established by the author of the analytical application, or (2) allowing the user of the application to set customized weights. In some embodiments, the control checks 728 represent industry best practices. Variances that raise best practice standards are scored positively, variances that deviate from industry best practices are scored negatively. Example best practice variance scores are shown in Table 8.

TABLE 8
Best Practice Assigned Variance Scores.

| Business Driver | Assigned Variance Score |
|---|---|
| Alpha Generation | 2.0 |
| Operational Risk | 1.5 |
| Scalabilty | 1.0 |
| Productivity | .5 |
| Profitability | .25 |

To illustrate the scoring of an activity workflow comparison to industry best practices, an example of the scored trade capture activity comparison to applicable control checks 728 is shown in Table 9.

TABLE 9
Trade Capture Comparison

| | Productivity | Scalability | Profitability | Alpha | Risk |
|---|---|---|---|---|---|
| Variance | Impact | Impact | Impact | Impact | Impact |
| Manual trade | −0.5 | −1.0 | −.25 | | −1.5 |
| verification | | | | | |
| No holdings | | | | | −1.5 |
| check before | | | | | |
| trade capture | | | | | |
| No | | | | | −1.5 |
| authorization | | | | | |
| check before | | | | | |
| trade capture | | | | | |
| No outbound | | | | | −1.5 |
| trade | | | | | |
| verification | | | | | |

To compute the score 730 for the trade capture activity comparison to industry best practices, or the Trade Capture Activity Control Check Score 730, the impressed base score of 50 is reduced by the sum of the scored variances. In this example, the sum of the variances is −7.75, resulting in a score of 42.25.

Step 314 is represented in the example workflow of FIG. 7C, where activity workflows 723 are compared to applicable control checks 728 to generate control scores 730.

Following the analysis of step 314, the functions 704 are then weighted vis-à-vis their importance to the business 702 using an algorithm designed to account for the interdependence of the functions 704 (step 316). In the example embodiment of FIGS. 7B and 7D, this step 316 is achieved by averaging/weighting 734 the previously determined function KBIs 720 to generate function weighting(s) 736. Different functions as detailed in Table 1 have a different importance to the business based on their relationship to drivers 740. Every function 704 impacts productivity 740A, scalability 740B, profitability 740C, and alpha 740D. However, in embodiments, because alpha is considered to be more important than profitability in evaluating an asset management business, functions 704 that are most important to alpha 740D have a higher weighting than functions 704 that are most important to profitability 740C.

Following step 316, the collective information generated in the prior steps—metrics (represented by measures 713 in FIG. 7B), KBIs (activity KBIs 714 and function KBIs 720), process workflow control check comparisons (control check scores 730) and function weightings 736—is then used to calculate the actual productivity, scalability, profitability and alpha generation levels of the business (step 318). These measures are intermediate calculations and expressed as the Operational Performance Benchmarks (OPBs) as they do not yet include an operational risk perspective. The OPBs provide an understanding of the interdependence of the business activities and functions and their relation to the business as a whole. This step 318 is depicted in the example of FIG. 7E, where productivity OPBs 740A, scalability OPBs 740B, profitability OPBs 740C, and alpha generation OPBs 740D are generated 738 from activity KBIs 714, function KBIs 720, control check scores 730 and/or function weightings 736. Different functions as detailed in Table 1 have a different importance to the business based on their relationship to drivers 740. Every function 704 impacts productivity 740A, scalability 740B, profitability 740C, and alpha 740D. However, in embodiments, because alpha is considered to be more important than profitability in evaluating an asset management business, functions 704 that are most important to alpha 740D have a higher weighting than functions 704 that are most important to profitability 740C.

After the Operational Performance Benchmarks have been computed, a risk assessment is performed (step 320). For this example, the risk assessment is based on four risk factors: people, processes, technology and external factors. Examples of risk factors are detailed in Table 10.

TABLE 10
Risk Factors.

| Risk Factors | |
|---|---|
| (such as 754 in | |
| FIG. 7F) | Drivers |
| People | Appropriateness of skills & experience |
| | Adequacy of resources |
| | Stability of staff |
| | Commitment to ethics |
| | Level of oversight |
| Processes | Effectiveness of control checks |
| | Prevalence of manual processes |
| | Awareness of risk exposures |
| | Accuracy & timeliness of data access, handling, |
| | processing & delivery |
| | Separation of responsibilities, control checks & |
| | oversight |
| | Clarity of policies and procedures |
| Technology | Reliability |
| | Redundancy |
| | Security |
| | Contingency |
| External Factors | Awareness of external factors (physical |
| | environment, counterparty, regulatory) |
| | Preparedness to respond to external factors |

Referring to the example data flow diagram of FIG. 7F, the risk assessment is accomplished by applying a risk assessment algorithm 752 to the collective data (metrics (represented by measures 713 in FIG. 7B), KBIs (activity KBIs 714 and function KBIs 720), best practice comparisons (control check scores 730), function weightings 736 and Operational Performance Benchmarks 740) as it effects the drivers for each Risk Factor. Such collective data is assigned reference number 750 in FIG. 7F. The risk assessment algorithm 752 includes risk metrics for each of the factors 754 in Table 10. That is, each Driver in Table 10 is assigned a grade 756, or score from 1-100 indicating how well the driver is performing. Such grade/score 756 is determined by applying that part of collective data 750 relevant to a given driver to a metric or algorithm applicable to that driver (similar in concept to metrics 710). For example, the Technology Risk Factor may have a 90 in Reliability, 80 in Redundancy, 67 in Security and 75 in Contingency. In this example these are the Risk Driver Ratings 756 for the Technology risk factor, and the Security driver is creating the highest risk for this risk factor.

The weighted average (see functional block 757 in FIG. 7F) of the Risk Driver Ratings 756 for each Risk Factor 754 is calculated to obtain the Risk Factor Weightings 758. The weighted average (see functional block 760) of the Risk Factor Weightings 758 is then calculated to obtain an overall Risk Assessment 762. Different Risk Factors as detailed in Table 10 have a different importance to the business based on their relationship to functions 704. For instance, people risk is more significant to skill based functions such as research and portfolio management and less significant in functions such as information technology and operations. Where a Risk Factor is more significant, it will have a higher weighting in the average functional block 760.

The inventive method calculates the enterprise risk level 324 of the business using an enterprise risk algorithm (similar to functional block 752) in the same fashion using the Risk Ratings for each Function (step 322). The enterprise risk score 324 measures the level of risk in the business 702 by using metrics to link Risk Factor Weighting 758 against business drivers. For example, a high level of people risk would have a higher impact on a business driver depending heavily on human skill (such as Alpha Generation 808), whereas a high level of technology risk would have a higher impact on a business driver depending heavily on technology (such as Productivity 802).

The inventive method culminates in computing a measure of the consistency potential of the business (step 328) by factoring the business drivers together using a consistency potential algorithm that measures the potential of the business to perform consistently in the future. Referring to the example data flow diagram in FIG. 7G, the consistency potential algorithm 772 is a combined weighted average of any one or more of the Performance Ratings, Risk Ratings, KBIs and OPBs of each Function (represented in FIG. 7G as collective data 770) to obtain final measures of productivity, scalability, profitability, alpha generation and operational risk for the business, or enterprise, as a whole (step 326). For example, step 326 may be performed by taking a weighted average of those portions of the collective data 770 applicable to a given business driver (where the weights are assigned based on the importance of the data to the business driver), where that weighted average represents the overall score for that business driver. This is repeated for each business driver (i.e., productivity, scalability, profitability, alpha generation and operational risk). In step 328, the assessment 330 of the consistency potential measures the potential of the business to perform consistently over time, thus providing a forward-looking perspective. For example, step 328 can be performed by taking a weighted average of the business driver scores (calculated in step 326), where the weights are based on the perceived importance of each business driver to the particular business 702.

3. Operational Examples

For further illustration of activity metrics 710 and their corresponding activity KBIs 714, as well as other processing of the invention, a number of exemplary metric sets and activity KBIs for specific activities are provided. Table 11 shows a simplified exemplary set of data with its corresponding metrics and KBI for Trade Error Resolution Activity, and is similar to the steps of FIG. 3 for Trade Capture Activity. Once experiential data is gathered (step 302—this step may be manual, automatic, or partially automatic), all of the subsequent steps in FIG. 3 are performed by a computer.

TABLE 11
Trade Error Resolution Activity.

| Step | Action | Example Data/Metrics/KBI/Logic |
|---|---|---|
| Collect Data | Compile experiential data on | Example Data 708: |
| | activities | No. of trade errors |
| | | No. of trade errors remedied |
| | | electronically |
| | | No. of trade errors caused by |
| | | counterparty error |
| Apply Metrics | Establish baseline of current | Metrics 710: |
| | operational performance, i.e., how | Avg. no. of daily trade errors |
| | well people, processes and technology | Avg. time to remedy trade errors |
| | are performing. | % of trade errors remedied |
| | | electronically |
| Generate KBI | Combine metrics using computed | Activity KBI 714: |
| | ratios, averages and percentages to | % of trade errors remedied before |
| | produce KBIs. | T + 2 electronically |
| Compute OPB | Compute productivity, scalability, | Weighting logic 738: |
| | profitability, and alpha generation by | Timely identification and quick |
| | aggregating, factoring and weighting | remediation of trade errors is key |
| | metrics, KBIs & best comparison | to controlling costs and risk. |
| | results. | |

Table 12 shows a simplified exemplary set of data with its corresponding metrics and KBI for Pricing Activity.

TABLE 12
Pricing Activity.

| Step | Action | Example Data/Metrics/KBI/Logic |
|---|---|---|
| Collect Data | Compile experiential data on | Example data 708: |
| | activities | No. of securities with missing prices |
| | | No. of manually priced securities |
| | | No. of securities with price |
| | | overrides |
| | | No. of unsupervised and non- |
| | | priced securities |
| Apply Metrics | Establish baseline of current | Metrics 710: |
| | operational performance, i.e., | Avg. %. of securities priced daily |
| | how well people, processes and | Avg. % of securities priced |
| | technology are performing. | manually |
| | | Avg. % of unsupervised and non- |
| | | priced securities. |
| | | Avg. % of securities priced |
| | | manually |
| Generate KBI | Combine metrics using | Activity KBI 716: |
| | computed ratios, averages and | % of securities with manual price |
| | percentages to produce KBIs. | overrides |
| Compute OPB | Compute productivity, | Weighting logic 738: |
| | scalability, profitability, and | As the frequency and number of |
| | alpha generation by aggregating, | manually priced securities |
| | factoring and weighting metrics, | increases, so do costs and risk. |
| | KBIs & best comparison results. | |

Table 13 shows a simplified exemplary set of data with its corresponding metrics and KBI for Reconciliation Activity.

TABLE 13
Reconciliation Activity

| Step | Action | Example Data/Metrics/KBI/Logic |
|---|---|---|
| Collect Data | Compile experiential data on activities | Example data 708: |
| | | Total no. of position breaks |
| | | No. of positions in portfolio |
| | | No. of position breaks found |
| | | through automated comparison |
| Apply Metrics | Establish baseline of current | Metrics 710: |
| | operational performance, i.e., | Avg. no. of position breaks |
| | how well people, processes and | % of total no. of positions with breaks |
| | technology are performing. | Avg. time to remedy position breaks |
| | | % of breaks identified electronically |
| Generate KBI | Combine metrics using computed ratios, | Activity KBI 714: |
| | averages and percentages to produce KBIs. | % of position breaks remedied in |
| | | less than 2 days and via 1 notification |
| Compute OPB | Compute productivity, | Weighting logic 738: |
| | scalability, profitability, and | Position breaks increase cost and risk |
| | alpha generation by aggregating, | |
| | factoring and weighting metrics, | |
| | KBIs & best comparison results. | |

Table 14 shows a simplified exemplary set of data with its corresponding metrics and KBI for Proxy Voting Activity.

TABLE 14
Proxy Voting Activity

| Step | Action | Example Data/Metrics/KBI/Logic |
|---|---|---|
| Collect Data | Compile experiential data on activities | Example data 708: |
| | | Total no. of votes to vote |
| | | No. of votes not voted |
| | | No. of votes voted manually |
| | | No. of votes archived |
| Apply Metrics | Establish baseline of current | Metrics 710: |
| | operational performance, i.e., how | % of votes voted manually |
| | well people, processes and | % of votes not voted |
| | technology are performing. | % of vote overrides |
| Generate KBI | Combine metrics using computed | Activity KBI 714: |
| | ratios, averages and percentages to | % of votes, voted error-free & archived |
| | produce KBIs. | |
| Compute OPB | Compute productivity, scalability, | Weighting logic 738: |
| | profitability, and alpha generation | Automation provides increased |
| | by aggregating, factoring and | efficiency with lower cost and risk. |
| | weighting metrics, KBIs & best | |
| | comparison results. | |

4. Example Components of an Asset Management Business

Example components of an asset management business according to embodiments of the invention are described in this section.

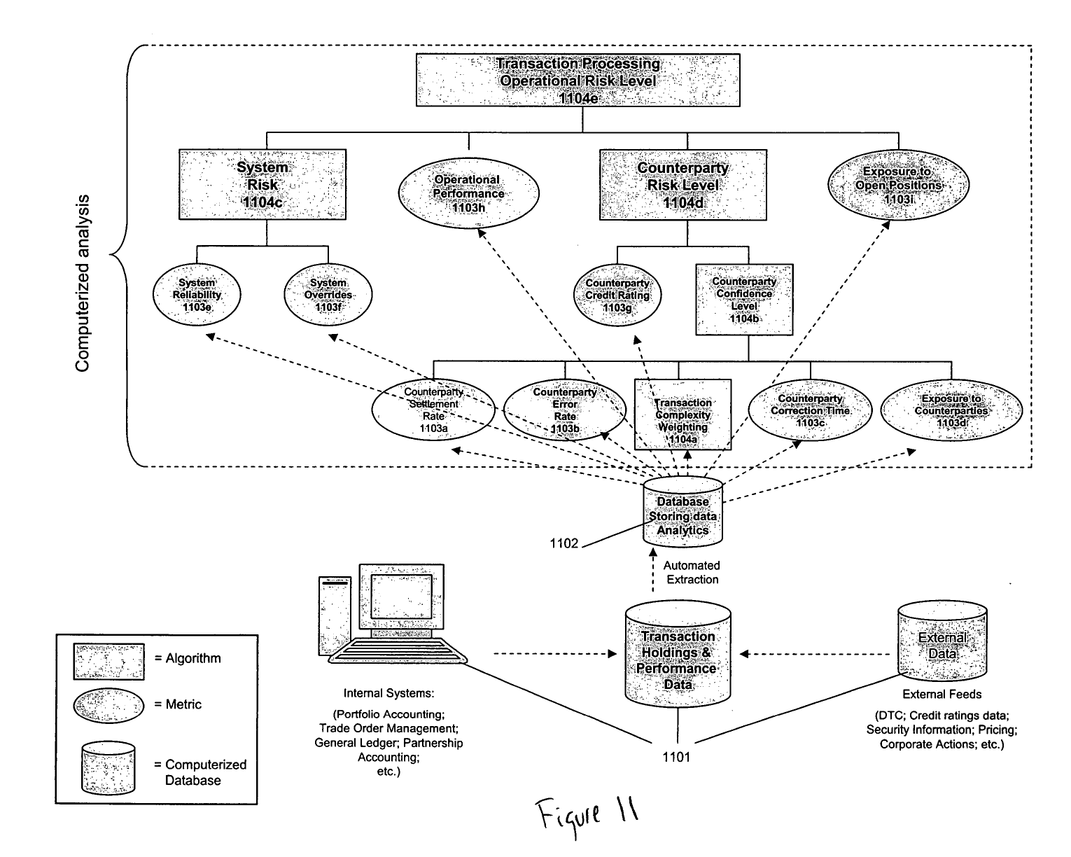

One inventive method relating to a component part of an asset management business measures the counterparty risk, counterparty effectiveness, settlement risk, and operational efficiency for the trade processing activity within the Operations Function of an asset management business and/or outsourced service provider. This method is represented, for example, in FIG. 11. Trade (or transaction) processing is part of the Operations business function as represented in Table 1. Measurements are created by assessing experiential data extracted from transaction processing systems such as trade order management systems, DTC systems, and portfolio accounting systems. The extracted data is fed into an application comprised of a series of metrics and algorithms that measure how well the component part of the asset management business is performing. The measurements provide levels of risk that particular type of security transactions will not settle. The measurements provide a quantitative framework and insights on the effectiveness of individual counterparties as well as measures of operational risk and efficiency within the trade processing function.

Two levels of analysis and perspective are provided, one at the functional level of the trade processing function (i.e., how well the activities are being performed) and the other, at the enterprise level (i.e., rolling up the various activity based measures) to understand the trade processing function overall and its risk exposure impact on the business. In this way, this embodiment of the present invention provides 1) an understanding of the interdependency of the various trade processing activities and their impact on the business as a whole, 2) the ability to quantify the effect and impact those interdependent relationships have on the business as a whole, and 3) the ability for an asset manager to detect and pinpoint the risk exposures within the trade processing function.

The method enables asset management businesses to utilize their own operational information to more effectively manage their businesses. Instead of having to rely on anecdotal information, they are able to manage their businesses as effectively as they manage their portfolios. The method also allows asset management businesses to provide quantitative information about their businesses to the financial institutions employing them as a supplement to traditional investment results and qualitative survey information.

To describe in further detail, the method for the trade processing function shown in FIG. 11 (1) identifies relevant and previously not utilized data elements contained within various computer systems and databases for extraction (1101); (2) aggregates the data for analysis (1102); (3) applies metrics to the data to produce specific measures (1103 (a-i)), and (4) combines the measures to evaluate risk, efficiency, and operational performance (1104 (a-e)).

The method in FIG. 11 relies on computers to compute metrics pertaining to trade processing activities. Counterparty settlement rate 1103a is computed by measuring the number of trades that settle as a percentage of all trades, and calculating the percentage for each counterparty that has traded with the asset management business over the defined period of time. Counterparty error rate 1103b is computed for each counterparty by measuring the number of transactions with errors as a percentage of total transactions. Counterparty correction time 1103c is computed for each counterparty by comparing the length of time it takes for an error in a transaction to be corrected. Exposure to counterparties 1103d is computed for each counterparty by calculating the number of trades that have been traded but not settled. System reliability 1103e is computed by calculating the percentage of days that transactions were processed on against total days available to process transactions. System overrides 1103f is computed by calculating the number of times a system administrator (such as a portfolio manager, operations manager, or information technology specialist) overrides previously installed controls within a portfolio accounting or trade order management system. Counterparty credit rating 1103g is computed by assigning third party (such as Standard & Poor's or Moody's) credit ratings to each counterparty. Operational performance 1103h is computed by calculating the percentage of transactions that settle on time. Exposure to open positions 1103i is computed by calculating the number of trades that have been made but have not yet settled (open positions) as a percentage of overall transactions, and the understanding the dollar amount of those open positions relative to the overall investment portfolio.

The method in FIG. 11 relies on computers to compute algorithms that incorporate previously calculated metrics. Transaction complexity weighting 1104a is calculated by assigning a score to individual securities based on the difficulty of settling a transaction. For instance, settling a trade of a common stock on the NASDAQ stock exchange is easier than settling an option traded on the CBOE. Settling an option on the CBOE is easier, however, than settling a privately negotiated interest-rate swap. The score can be assigned based on a user's understanding of security complexity or based on calculations of prior performance in settling securities. Counterparty confidence level 1104b is calculated by averaging (either as a straight average or weighted average) the results for counterparty settlement rate 1103a, counterparty error rate 1103b, transaction complexity weighting 1104a, counterparty correction time 1103c, and exposure to counterparties 1103d. Counterparty risk level 1104d is calculated by averaging the counterparty credit rating 1103g and the counterparty confidence level 1104b. System risk 1104c is calculated by averaging system reliability 1103e and system overrides 1103f.

An overall operational risk level for transaction processing 1104e is calculated by averaging (either as a straight average or weighted average) the results for system risk 1104c, operational performance 1103h, counterparty risk level 1104d, and exposure to open positions 1103i.

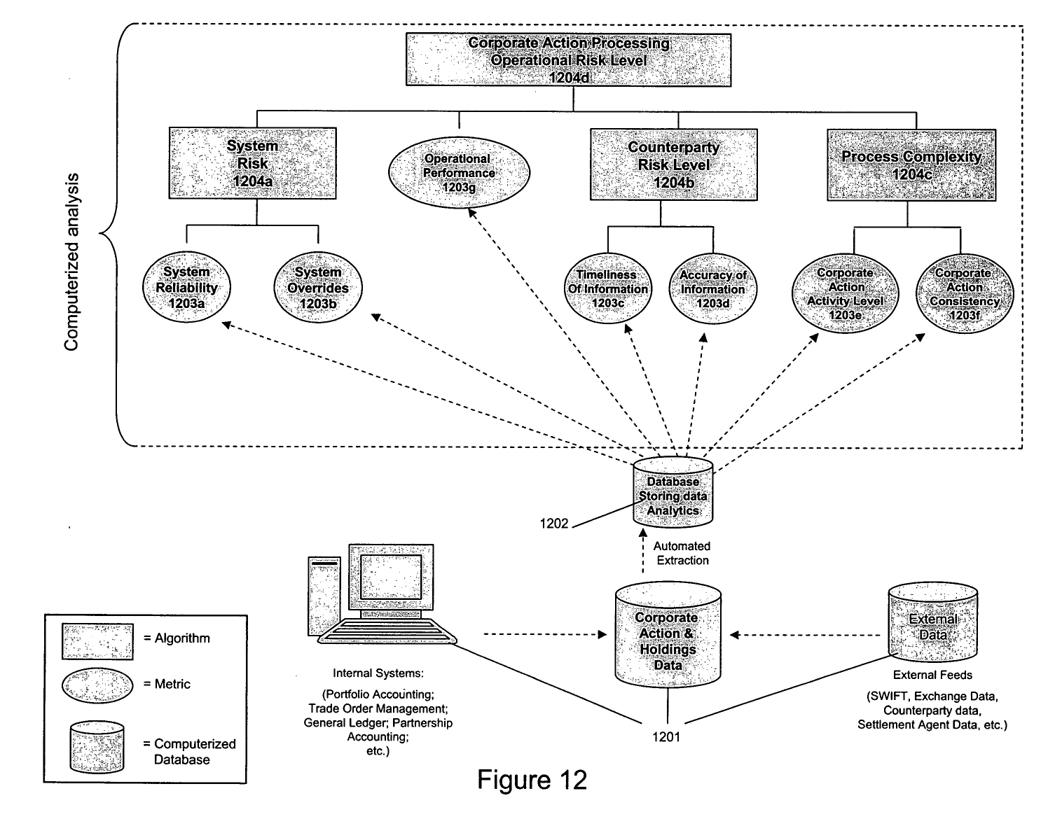

A second inventive method relating to a component part of an asset management business measures the risk, performance, and potential of the corporate action processing function of an asset management business and/or outsourced service provider. This method is represented in FIG. 12. Corporate actions processing is part of the Operations business function as represented in Table 1. Measurements are created by assessing experiential data extracted from the systems associated with corporate action processing, such as portfolio accounting systems. The extracted data is fed into an application comprised of a series of metrics and algorithms that measure how well the corporate action processing component part of the asset management business is performing. The measurements provide a quantitative framework and insights on the effectiveness and risk level associated with the corporate action processing activity.

Two levels of analysis and perspective are provided, one at the functional level of the corporate action processing function (i.e., how well the activities are being performed) and the other, at the enterprise level (i.e., rolling up the various activity based measures) to understand the trade processing function overall and its risk exposure impact on the business. In this way, this embodiment of the present invention provides 1) an understanding of the interdependency of the various corporate action processing activities and their impact on the business as a whole, 2) the ability to quantify the effect and impact those interdependent relationships have on the business as a whole, and 3) the ability for an asset manager to detect and pinpoint the risk exposures within the corporate action processing function.

To describe in further detail, the method for the corporate action processing function shown in FIG. 12 (1) identifies relevant and previously not utilized data elements contained within various computer systems and databases for extraction (1201); (2) aggregates the data for analysis (1202); (3) applies metrics to the data to produce specific measures (1203a-g), and (4) combines the measures to evaluate risk, efficiency, and operational performance (1204a-d).

The method in FIG. 12 relies on computers to compute metrics pertaining to corporate action processing activities. System reliability 1203a is computed by calculating the number of days the system processes corporate actions as a percentage of total days. System overrides 1203b are computed by calculating the number of times a system administrator or other professional overrides internal control checks. Timeliness of information 1203c is calculated by determining when information relating to corporate actions is received from counterparties. Accuracy of information 1203d is calculated by determining if information received from counterparties has been subsequently revised or corrected. Corporate action activity level 1203e is calculated by determining the number of corporate actions processed. Corporate action consistency 1203f is calculated by determining the ways corporate actions are incorporated into the investment portfolio. Operational performance 1203g is calculated by determining the number of error free corporate actions processed as a percentage of total corporate actions.

The method in FIG. 12 relies on computers to compute algorithms that incorporate previously calculated metrics. System risk 1204a is calculated by averaging system reliability 1203a and system overrides 1203b. Counterparty risk 1204b level is computed for each counterparty by averaging (as a weighted average or simple average) timeliness of information 1203c and accuracy of information 1203d. Process complexity 1204c is computed by averaging (as a weighted average or simple average) corporate action activity level 1203e and corporate action consistency 1203f.

An overall operational risk level for corporate action processing 1204d is calculated by averaging (either as a straight average or weighted average) the results for system risk 1204a, operational performance 1203g, counterparty risk level 1204b, and process complexity 1204c.

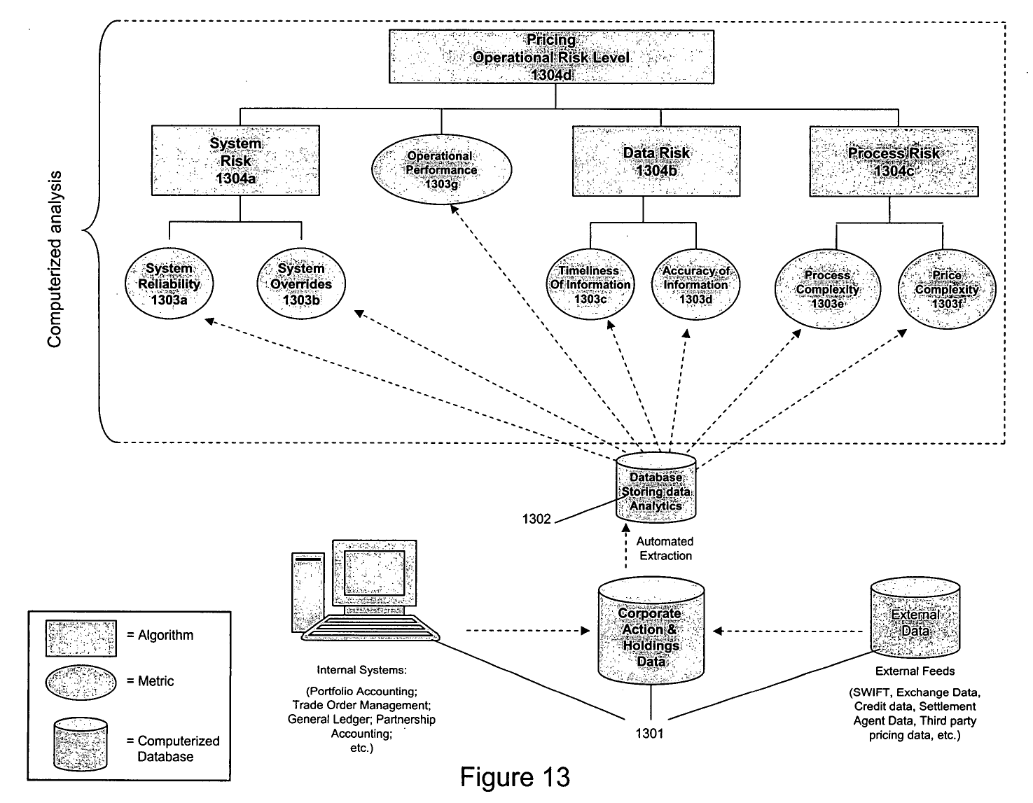

A third inventive method of one component part of an asset management business measures the risk, performance, and potential of the security pricing function. This method is represented in FIG. 13. Security pricing is part of the Controller business function as represented in FIG. 1. Measurements are created by assessing experiential data extracted from the systems associated with security pricing, such as portfolio accounting systems. The extracted data is fed into an application comprised of a series of metrics and algorithms that measure how well the security pricing component part of the asset management business is performing. The measurements provide a quantitative framework and insights on the effectiveness and risk level associated with the security pricing activity.

Two levels of analysis and perspective are provided, one at the functional level of the security pricing function (i.e., how well the activities are being performed) and the other, at the enterprise level (i.e., rolling up the various activity based measures) to understand the security pricing function overall and its risk exposure impact on the business. In this way, this embodiment of the present invention provides 1) an understanding of the interdependency of the various security pricing activities and their impact on the business as a whole, 2) the ability to quantify the effect and impact those interdependent relationships have on the business as a whole, and 3) the ability for an asset manager to detect and pinpoint the risk exposures within the security pricing function.

To describe in further detail, the method for the security pricing function of FIG. 13 (1) identifies relevant and previously not utilized data elements contained within various computer systems and databases for extraction (1301); (2) aggregates the data for analysis (1302); (3) applies metrics to the data to produce specific measures (1303a-g), and (4) combines the measures to evaluate risk, efficiency, and operational performance (1304a-d).

The method in FIG. 13 relies on computers to compute metrics pertaining to pricing activities. System reliability 1303a is computed by determining the days pricing is performed relative to possible days pricing could be performed. System overrides 1303b is calculated by determining the number of instances an administrator or portfolio manager overrides the established pricing process for a security and inserts a new price for the security. Timeliness of information 1303c is calculated by determining when pricing data is received. Accuracy of information 1303d is calculated by determining if data is subsequently corrected or revised. Process complexity 1303e is calculated by determining how difficult a security is to price. This can be self-scored or determined based on historical difficulties in pricing securities (pricing a common stock is easy, while pricing a highly illiquid security is more difficult). Pricing complexity 1303f is calculated by determining the number of pricing elements that are involved in a security pricing. This can be self-scored or determined base do historical performance in pricing securities. Some securities are easy to price because they have a single market price on an exchange. Other illiquid fixed income securities, however, may have a dozen different data elements required to price the security. Operational performance 1303g is calculated by determining the level at which securities are priced error-free.

The method in FIG. 13 relies on computers to compute algorithms that incorporate previously calculated metrics. System risk 1304a is computed by averaging system reliability 1303a and system overrides 1303b. Data risk 1304b is determined by averaging (as a weighted average or simple average) timeliness of information 1303c and accuracy of information 1303d. Process risk 1304c is calculated by averaging (as a weighted average or simple average) process complexity 1303e and price complexity 1303f.

An overall operational risk level for pricing 1304d is calculated by averaging (either as a straight average or weighted average) the results for system risk 1304a, operational performance 1303g, data risk 1304b, and process risk 1304c.

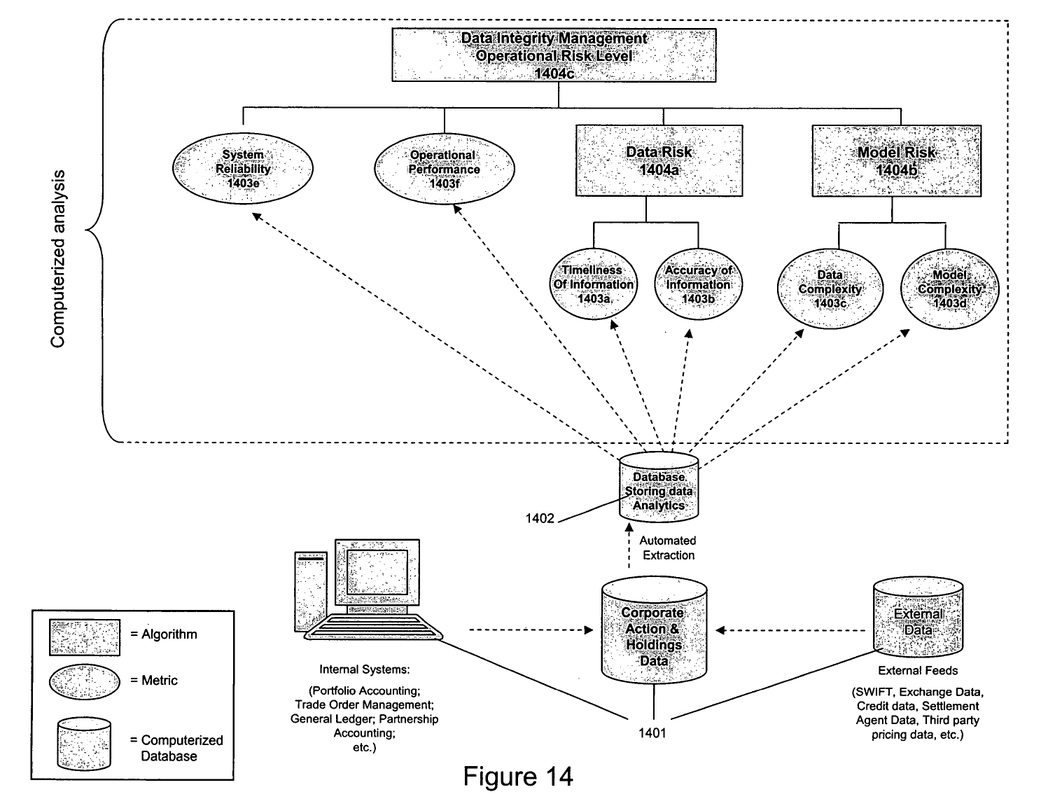

A fourth inventive method of one component part of an asset management business measures the risk, performance, and potential of the data management function of an asset management business and/or outsourced service provider. This method is represented in FIG. 14. Data management is part of the information technology business function in Table 1. Measurements are created by assessing experiential data extracted from the systems associated with data management, such as portfolio accounting systems. The extracted data is fed into an application comprised of a series of metrics and algorithms that measure how well the data management component part of the asset management business is performing. The measurements provide a quantitative framework and insights on the effectiveness and risk level associated with the data management activity.

Two levels of analysis and perspective are provided, one at the functional level of the data management function (i.e., how well the activities are being performed) and the other, at the enterprise level (i.e., rolling up the various activity based measures) to understand the data management function overall and its risk exposure impact on the business. In this way, this embodiment of the present invention provides 1) an understanding of the interdependency of the various data management activities and their impact on the business as a whole, 2) the ability to quantify the effect and impact those interdependent relationships have on the business as a whole, and 3) the ability for an asset manager to detect and pinpoint the risk exposures within the data management function.

To describe in further detail, the method for the data management function of FIG. 14 (1) identifies relevant and previously not utilized data elements contained within various computer systems and databases for extraction (1401); (2) aggregates the data for analysis (1402); (3) applies metrics to the data to produce specific measures (1403a-f), and (4) combines the measures to evaluate risk, efficiency, and operational performance (1404a-c).

The method in FIG. 14 relies on computers to compute metrics pertaining to data management activities. Timeliness of information 1403a is calculated by determining when information is received. Accuracy of information 1403b is calculated by determining if information received is subsequently revised or corrected. Data complexity 1403c is computed by determining the level of complexity in data received. This is self-scored or determined based on a comparison of the data received relative to other data. Model complexity 1403d is calculated by determining the data requirements of various computer systems in the firm (such as portfolio accounting systems, risk management systems, etc.). Operational performance 1403f is determined by determining the level at which data managed in the firm is without error. This can be determined over a period of time or as a percentage of overall data managed.

The method in FIG. 14 relies on computers to compute algorithms that incorporate previously calculated metrics. Data risk 1404a is computed by averaging (as a weighted average or simple average) timeliness of information 1403a and accuracy of information 1403b. Model risk 1404b is calculated by averaging (as a weighted average or simple average) data complexity 1403c and model complexity 1403d.

An overall operational risk level for data management 1404c is calculated by averaging (either as a straight average or weighted average) the results for system reliability 1403e, operational performance 1403f, data risk 1404a, and model risk 1404b.

The methods described herein enable asset management businesses to utilize their own operational information to more effectively manage their businesses. Instead of having to rely on anecdotal information, they are able to manage their businesses as effectively as they manage their portfolios. The method also allows asset management businesses to provide quantitative information about their businesses to the financial institutions employing them as a supplement to traditional investment results and qualitative survey information.

The methods described herein enable institutional investors to quantitatively evaluate the business infrastructures and operational risk levels of the asset managers they employ or are considering for employment. The method also allows investors to quantitatively understand the stability and scalability of an asset management business. Further, financial institutions can understand an investment strategy within the context of the business supporting it rather than looking at the strategy in isolation.

The methods described herein enable government regulators to understand operational risk levels within asset management business. By understanding the risks within firms regulators can better understand how to minimize systemic risk within markets.

The methods described herein enable asset management industry participants and government regulators to better understand counterparty risk levels and their potential impact on systemic risk.

5. Structural Description of Embodiments of the Invention

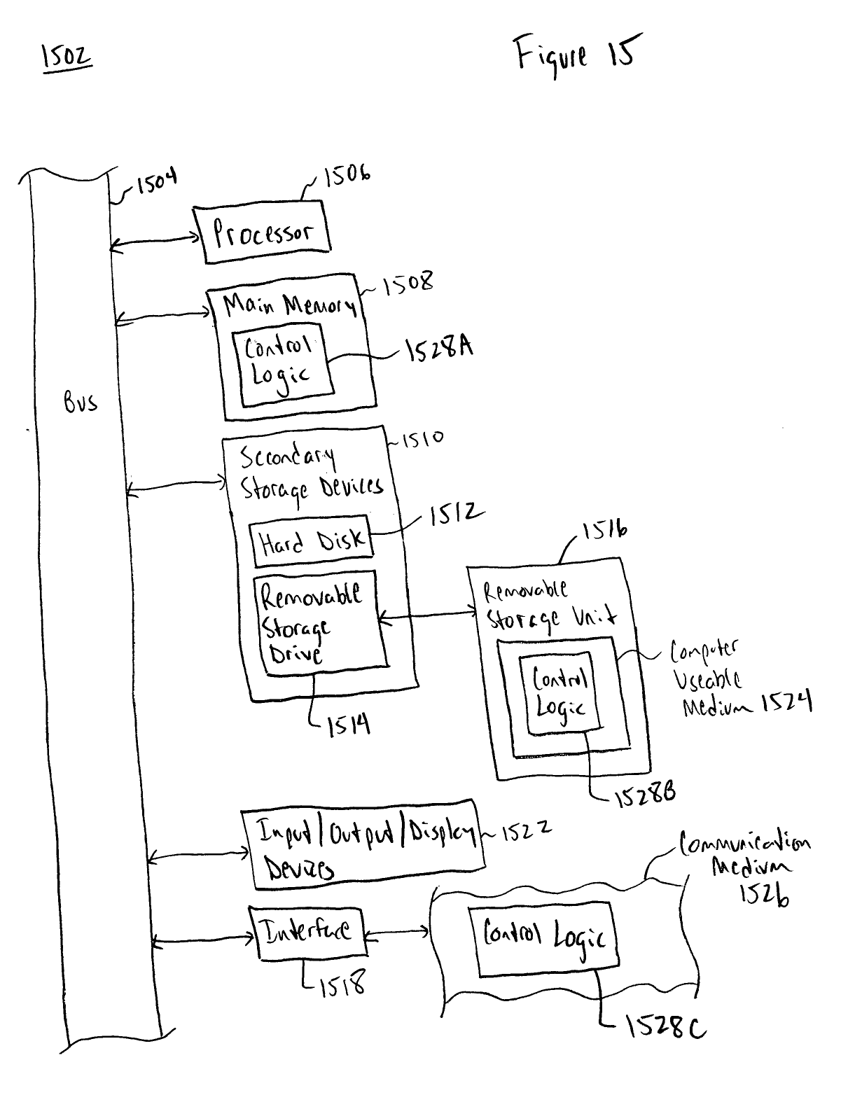

Certain embodiments of the present invention are implemented using well known computers, such as a computer 1502 shown in FIG. 15. The computer 1502 can be any commercially available and well known computer capable of performing the functions described herein, such as computers available from IBM, Apple, Sun, HP, Dell, Compaq, etc.

The computer 1502 includes one or more processors (also called central processing units, or CPUs), such as a processor 1506. The processor 1506 is connected to a communication bus 1504. The computer 1502 also includes a main or primary memory 1508, preferably random access memory (RAM). The primary memory 1508 has stored therein control logic 1528A (also herein called computer software), and data.

The computer 1502 also includes one or more secondary storage devices 1510. The secondary storage devices 1510 include, for example, a hard disk drive 1512 and/or a removable storage device or drive 1514. The removable storage drive 1514 represents a DVD drive, a compact disk drive, a magnetic storage device, an optical storage device, tape backup, etc.

The removable storage drive 1514 interacts with a removable storage unit 1516 (in some embodiments the storage unit 1516 is not removable from the device 1514). As will be appreciated, the removable storage unit 1516 includes a computer usable or readable storage medium 1524 having stored therein computer software (control logic 1528B) and/or data. The removable storage drive 1514 reads from and/or writes to the removable storage unit 1516 in a well known manner.

Removable storage unit 1516, also called a program storage device or a computer program product, represents a floppy disk, magnetic tape, compact disk, DVD, optical storage disk, or any other computer data storage device. Program storage devices or computer program products also include any device in which computer programs can be stored, such as hard drives, ROM or memory cards, etc.

Control logic (or computer software) 1528, when executed, enable the computer 1502 to perform the functions of embodiments of the present invention as described herein. In particular, the computer programs 1528, when executed, enable the processor 1506 to perform the functions described herein. Accordingly, such computer programs 1528 represent controllers of the computer 1502.

The computer 1502 also input/output/display devices 1522, such as monitors, keyboards, pointing devices, etc.

The computer 1502 further includes a communication or network interface 1518. The network interface 1518 enables the computer 1502 to communicate with remote devices over one or more communication mediums 1526. For example, the network interface 1518 may allow the computer 1502 to communicate over communication networks, such as LANs, WANs, the Internet, etc. Communication mediums 1526 include wired or wireless mediums. Software 1528C is transmitted over such communication mediums 1526. The electrical/magnetic signals having contained therein computer programs 1528C also represent computer program product(s).

The invention can work with software, hardware, and operating system implementations other than those described herein. Any software, hardware, and operating system implementations suitable for performing the functions described herein can be used.

In an embodiment, the present invention is directed to computer program products or program storage devices having software that enables the computer 1502 to perform any combination of the functions described herein.

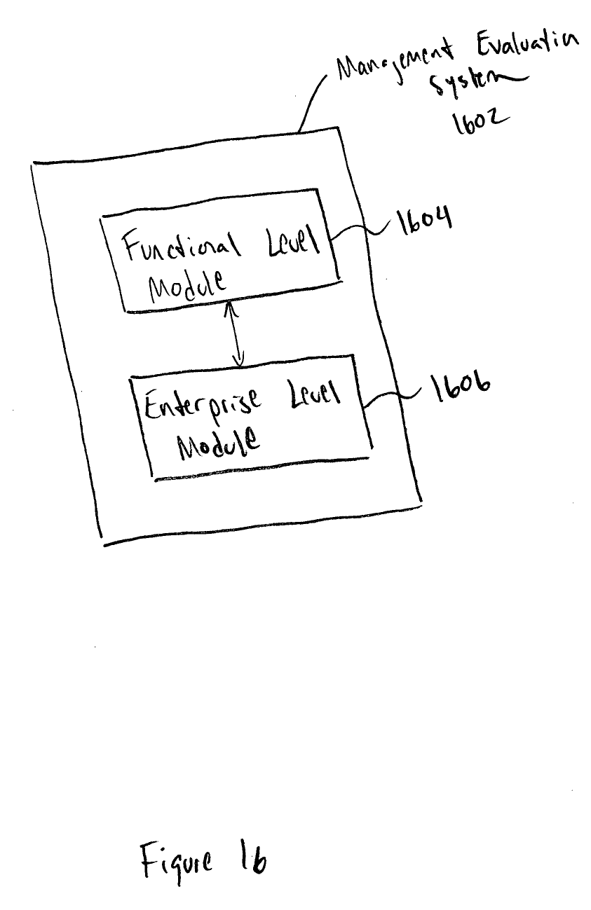

FIG. 16 illustrates an asset management evaluation system 1602 according to an embodiment of the invention. The asset management evaluation system 1602 performs the functions described herein. In particular, the asset management evaluation system 1602 includes a functional level module 1604 that evaluates a business from an activity level and a functional level using experiential data of the business, as well as an enterprise level module 1606 that evaluates the business from an enterprise level, again using experiential data of the business, in accordance with the teachings contained herein. In embodiments, the management evaluation system 1602 is implemented using one or more computers, such as that shown in FIG. 15.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like and combinations thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for evaluating performance and risk of an asset management business, comprising:
(a) gathering experiential data resulting from performance of activities relating to functions of said business, said experiential data comprising process workflows of said activities; and
(b) determining whether said process workflows include applicable control checks; and
(c) generating control scores of said process workflows based on results of step (b), wherein said control scores are an indication of risk of said activities.

2. A system for evaluating performance of an asset management business, wherein said business comprises a plurality of functions each including a plurality of activities, the system comprising:
a functional level module that generates quantitative measures related to evaluation of said business on an activity level and on a functional level; and
an enterprise level module, coupled to said functional level module, that generates measures related to evaluation of said business on an enterprise level.

3. A method for evaluating counterparty performance and risk, comprising:
(a) gathering and analyzing experiential counterparty trade processing data;
(b) measuring at least one of timeliness, accuracy, and completeness of counterparty data to assess counterparty effectiveness; and
(c) combining at least one of counterparty effectiveness, data, and measurements with external counterparty credit data to quantify counterparty risk.
